(19) United States
(12) Patent Application Publication
(10) Pub. No.: US 2024/0126959 A1
(43) Pub. Date: Apr. 18, 2024

(54) RESERVOIR MODELING

(71) Applicant: Schlumberger Technology Corporation, Sugar Land, TX (US)

(72) Inventors: Kassem Ghorayeb, Abu Dhabi (AE); Hussein Mustapha, Abu Dhabi (AE)

(21) Appl. No.: 18/546,108

(22) PCT Filed: Feb. 11, 2022
(86) PCT No.: PCT/US2022/070640

§ 371 Date: Aug. 11, 2023

Related U.S. Application Data
(60) Provisional application No. 63/200,057, filed on Feb. 12, 2021.

(51) Int. Cl. G06F 30/28

(52) U.S. Cl. CPC G06F 30/28

(57) ABSTRACT

A method can include receiving sample information for reservoir fluid samples and automatically selecting one or more equations of state from a plurality of different equations of state, which can suitably match the reservoir fluid samples and/or other samples. Such a method can also include automatically generating initial conditions based at least in part on sample information where such initial conditions along with one or more selected equations of state can be utilized in simulating physical phenomena using at least a reservoir model to generate simulation results. Such a method can include outputting at least a portion of the simulation results, which may be utilized in one or more processes.

### RELATED APPLICATION

This application claims priority to and the benefit of a U.S. Provisional Application having Ser. No. 63/200,057, filed 12 Feb. 2021, which is incorporated by reference herein.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Hydrocarbon fluids, which may be referred to as hydrocarbons, can be characterized in various manners. For example, their behavior can be characterized via pressure, volume and temperature analysis (PVT analysis), which can involve analysis of phase diagrams (e.g., phase plots). In a reservoir, variables such as pressure and temperature can differ spatially, which can give rise to different hydrocarbon phases, that may be characterized as gas or liquid phases. In a reservoir, fluid may include multiple components such as, for example, a range of hydrocarbons that can be classified according to number of carbon atoms, number of hydrogen atoms, etc. The accumulation of hydrocarbons in a reservoir can be a process that occurs over many years such that at present time (e.g., consider a time span of reservoir exploration, development and production), reservoir fluid may appear to be in an equilibrium state. To understand the present day state, fluid samples can be taken and analyzed.

As to reservoir development and production, simulations can be instructive, for example, to determine a volume of producible hydrocarbons held in a reservoir, to determine well placement, etc. Reservoir simulation involves generation of an appropriate spatial model along with specifying how hydrocarbons may be distributed within the spatial model, which may be considered a process of setting initial conditions for a simulator where the simulator can generate simulation results that honor various physical laws and provide for more accurate distributions (e.g., at a current time, a future time, etc.).

In reservoir simulation, the process of setting initial conditions can be a painstaking manual process aided by an interactive application (e.g., a PVT application). Such a process involves analysis of fluid samples, equations of state (EoSs), and estimating fluid variations with respect to depth. Where initial conditions do not adequately represent how fluid is actually distributed, a simulation may not necessarily converge to a solution, which can cause revisiting the manual process in an effort to arrive at better initial conditions. As many decisions, whether design, operational or other, depend on simulation results, a need exists for improved processes for going from fluid samples to initial conditions. Such improved processes can also be of assistance where a reservoir is in fluid communication with a surface network, where simulation of the reservoir and the surface network, as a system, demands appropriate initial conditions.

### SUMMARY

A method can include receiving sample information for reservoir fluid samples; automatically selecting one or more equations of state from a plurality of different equations of state; automatically generating initial conditions based at least in part on the sample information; simulating physical phenomena using at least a reservoir model to generate simulation results, where the simulating utilizes the selected one or more equations of state and the initial conditions; and outputting at least a portion of the simulation results.

A system can include a processor; a memory accessibly by the processor; and instructions stored in the memory and executable by the processor to instruct the system to: receive sample information for reservoir fluid samples; automatically select one or more equations of state from a plurality of different equations of state; automatically generate initial conditions based at least in part on the sample information; perform simulation of physical phenomena using at least a reservoir model to generate simulation results, where the simulation utilizes the selected one or more equations of state and the initial conditions; and outputting at least a portion of the simulation results.

One or more computer-readable storage media can include processor-executable instructions where the processor-executable instructions include instructions to instruct a computing system to: receive sample information for reservoir fluid samples; automatically select one or more equations of state from a plurality of different equations of state; automatically generate initial conditions based at least in part on the sample information; perform simulation of physical phenomena using at least a reservoir model to generate simulation results, where the simulation utilizes the selected one or more equations of state and the initial conditions; and outputting at least a portion of the simulation results.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and examples of equipment in a geologic environment;

FIG. 2 illustrates examples of equipment in a geologic environment and an example of a system;

FIG. 3 illustrates an example of a system;

FIG. 4 illustrates an example of a system with respect to an example of a geologic environment;

FIG. 5 illustrates an example of a system with respect to an example of a geologic environment;

FIG. 6 illustrates an example of a method;

FIG. 7 illustrates an example of a method;

FIG. 8 illustrates example scenarios;

FIG. 9 illustrates an example of a method;

FIG. 10 illustrates examples of methods;

FIG. 11 illustrates examples of methods;

FIG. 12 illustrates example diagrams of a scenario;

FIG. 13 illustrates an example of a method;

FIG. 14 illustrates an example of a graphical user interface;

FIG. 15 illustrates examples of graphical user interfaces;

FIG. 16 illustrates an example of a method;

FIG. 17 illustrates an example of a framework;

FIG. 18 illustrates an example of a method and an example of a system; and

FIG. 19 illustrates example components of a system and a networked system.

### DETAILED DESCRIPTION

As explained, many decisions, whether design, operational or other, depend on simulation results, where improved processes for going from fluid samples to initial conditions for model-based simulation can be beneficial, particularly where a model or models represent one or more reservoirs that are in fluid communication with one or more surface networks via a number of wells. As an example, a method can include receiving sample information for reservoir fluid samples; automatically selecting one or more equations of state from a plurality of different equations of state; automatically generating initial conditions based at least in part on the sample information; simulating physical phenomena using at least a reservoir model to generate simulation results, where the simulating utilizes the selected one or more equations of state and the initial conditions; and outputting at least a portion of the simulation results. Such a method can improve operation of a simulator, for example, by reducing number of iterations for convergence to a solution and/or improving chances of convergence to a solution. Further, such a solution (e.g., simulation results) can be more accurate, particularly where compartmentalization exists in a reservoir or reservoirs. As an example, such a method can also include automatically selecting one or more equations of state for one or more surface networks where, for example, a simulation may include simulating physical phenomena in a system that includes one or more reservoirs with wells that provide fluid communication with the one or more surface networks.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

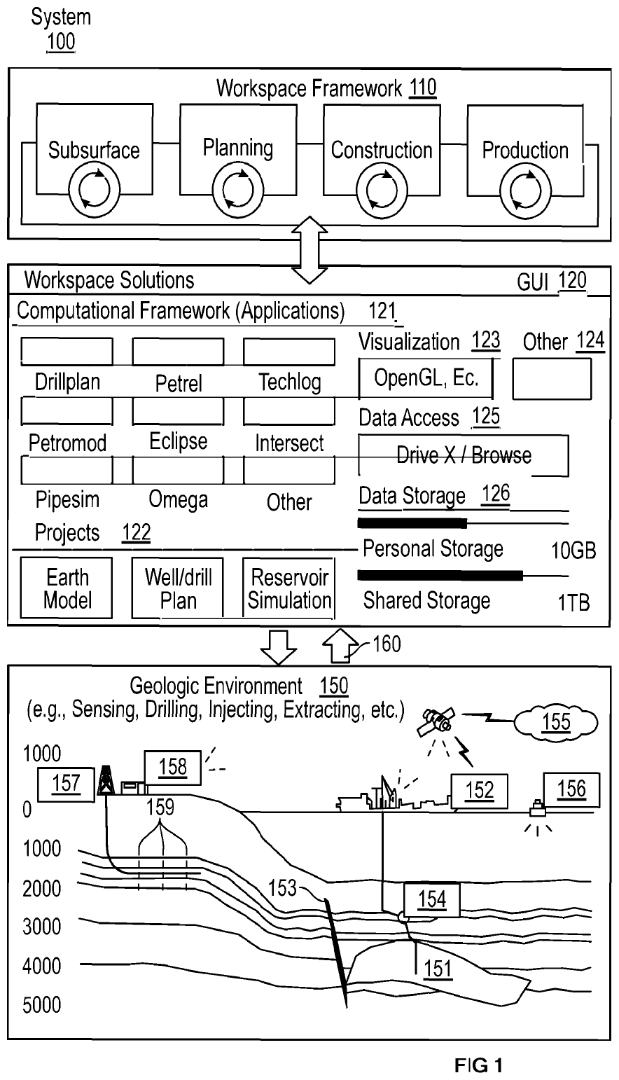

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As an example, a system may include a computational environment that can include various features of the DELFI environment (Schlumberger Limited, Houston, Texas), which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, INTERSECT, VISAGE, MANGROVE, OMEGA and PETROMOD frameworks (Schlumberger Limited, Houston, Texas).

As an example, a system may include features of a simulation framework that provides components that allow for optimization of exploration and development operations (e.g., “E&P” operations). A framework may include seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. As an example, various components may be implemented as add-ons (or plug-ins) that conform to and operate according to specifications of a framework environment (e.g., according to application programming interface (API) specifications, etc.).

The aforementioned DELFI environment is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework, a measurements framework, a mechanical earth modeling (MEM) framework, an exploration risk, resource, and value assessment framework, a reservoir simulation framework, a surface facilities framework, a stimulation framework, etc. As an example, one or more methods may be implemented at least in part via a framework (e.g., a computational framework) and/or an environment (e.g., a computational environment).

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks that may be part of a DELFI environment.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can provide for implementing various tasks in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (chemical EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such a converter may provide for interoperability, integration of code from one or more sources, etc.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.). As an example, a visualization framework such as the OpenGL framework (The Khronos Group, Inc., Beaverton, Oregon) may be utilized for visualizations. The OpenGL framework provides a cross-language, cross-platform application programming interface for rendering 2D and 3D vector graphics where the API may be used to interact with a graphics processing unit (or units), to achieve hardware-accelerated rendering.

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator, etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The MANGROVE simulator provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

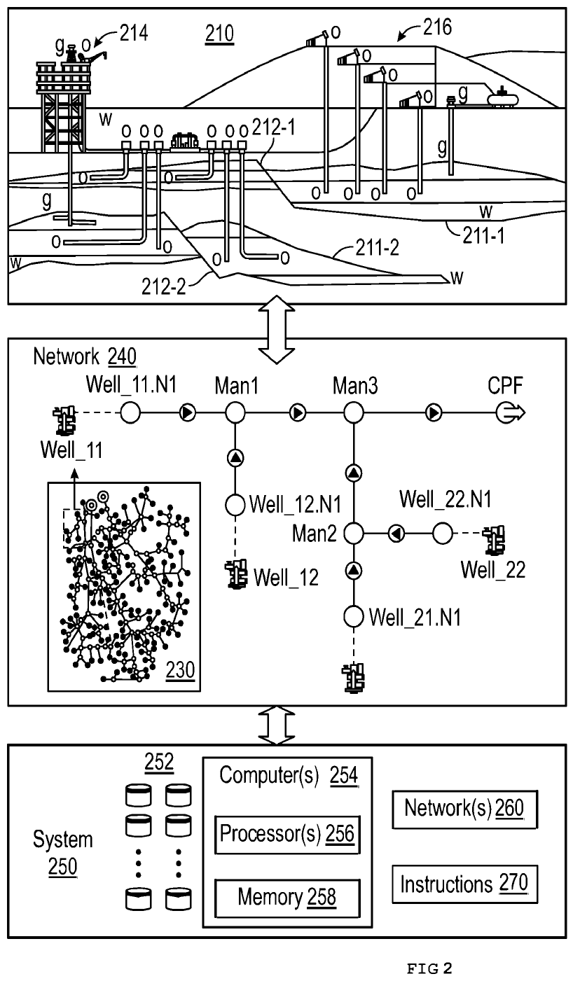

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or one or more other types of modeling. As an example, one or more methods, techniques, etc. may be performed using one or more sets of instructions, which may be, for example, the instructions 270 of FIG. 2.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc. As an example, one or more portions of a production network (e.g., optionally sub-networks, etc.) or a group of signal components and/or controllers may be modeled as sub-models.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include instructions (e.g., processor-executable instructions) to facilitate generation of a flow simulation model. For example, instructions may provide for modeling completions for vertical wells, completions for horizontal wells, completions for fractured wells, etc. A modeling framework may include instructions for particular types of equations, for example, black-oil equations, equations of state (EoSs), etc. A modeling framework may include instructions for artificial lift, for example, to model fluid injection, fluid pumping, etc. As an example, consider a set of instructions (e.g., a component) that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, sets of conservation equations for mass momentum and energy describing single, two or three phase flow (e.g., according to one or more of a LEDAFLOW (Kongsberg Oil & Gas Technologies AS, Sandvika, Norway), OLGA model (Schlumberger Ltd, Houston, Texas), TUFFP unified mechanistic models (Tulsa University Fluid Flow Projects, Tulsa, Oklahoma), etc.).

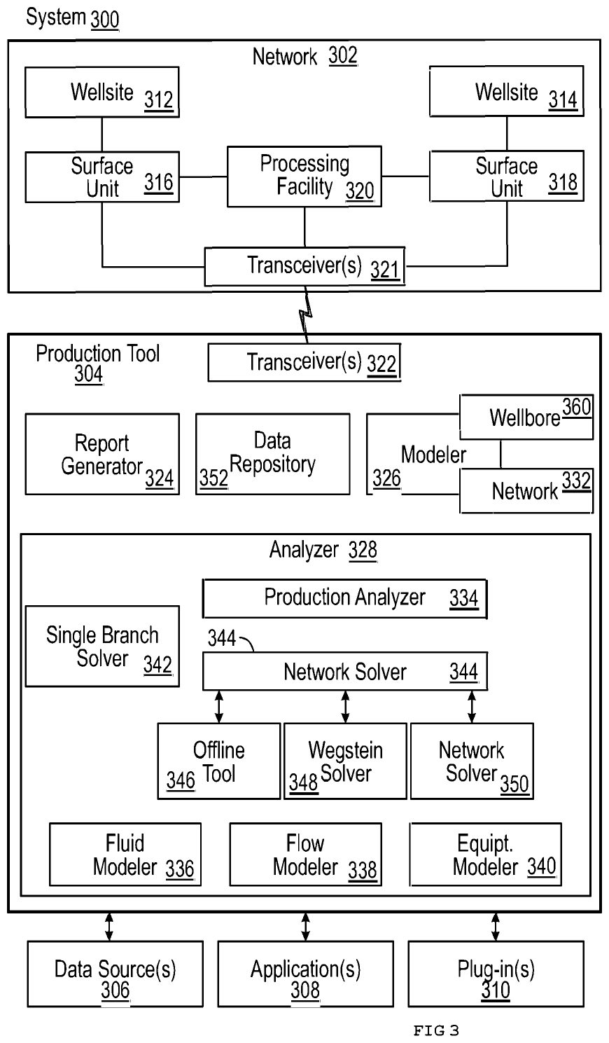

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects wellsites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors. Such sensors may include sensors for measuring flow rate, water cut, gas lift rate, pressure, and/or other such variables related to measuring and monitoring hydrocarbon production. As shown, the oilfield network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the oilfield modeler 326 can include functionality to create a model of a wellbore and an oilfield network where the wellbore is in fluid communication with a reservoir. As shown, the oilfield modeler 326 includes a wellbore modeler 360 and a network modeler 332. As an example, the wellbore modeler 360 can allow a user to create a graphical wellbore model or single branch model. As an example, a wellbore model can define operating parameters (e.g., actual, theoretical, etc.) of a wellbore (e.g., pressure, flow rate, etc.). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 360 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g., a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 348, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models, which can involve using one or more equations of state (EoSs). The fluid modeler 336 may include functionality to model oil, gas, water, hydrate, wax, asphaltene phases, etc. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottomhole pressure and flowrate. As an example, equations may account for vertical, horizontal or angled arrangements of equipment. Various examples of equations may be found in a dynamic multiphase flow simulator such as the simulator of the OLGA simulation framework (Schlumberger Limited, Houston, TX), which may be implemented for design and diagnostic analysis of oil and gas production systems. As an example, a simulation framework may include one or more sets of instructions for building a model; for fluid and multiphase flow modeling; for reservoir, well and completion modeling; for field equipment modeling; and for operations (e.g., artificial lift, gas lift, wax prediction, nodal analysis, network analysis, field planning, multi-well analysis, etc.).

As an example, a system may implement equations that include dynamic conservation equations for momentum, mass and energy. As an example, pressure and momentum can be solved implicitly and simultaneously and, for example, conservation of mass and energy (e.g., temperature) may be solved in succeeding separate stages.

As an example, an equation for pressure differential can account for factors such as fluid potential energy (e.g., hydrostatic pressure), friction (e.g., shear stress between conduit wall and fluid), and acceleration (e.g., change in fluid velocity). In addition, as mentioned, equations can be used to take into account dynamic aspects. For example, equations can account for time and forces to accelerate and decelerate fluid (e.g., and objects) inserted into multiphase flow (e.g., consider pigs, etc.). As an example, an approach may consider the time it takes to conserve mass and energy (e.g., an amount of time it takes to drain a system, pipeline or vessel). As an example, an approach may consider ramp-up time for production, for example, from one production rate to another production rate, etc. As an example, an approach may consider time it takes before a first condensate appears at an outlet of a production network during startup, etc.

As an example, an equation for a pressure differential (e.g., ΔP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

As an example, a method can include defining variables and residual equations as well as branches in an oilfield network that may include a number of equipment items. As an example, a branch may be divided into sub-branches with each sub-branch containing a single equipment item. As an example, a new node may be used to join each pair of sub-branches. In such an example, primary Newton-Raphson variables can include a flow (Q_{ib}) in each sub-branch in the network and a pressure Pᵢₙ at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used.

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an Infochem Multiflash model (Infochem Computer Services Ltd., London, UK), an equipment model, etc. (e.g., consider one or more simulators like HYSYS (AspenTech, Burlington, Massachusetts), UNISIM (Honeywell, Morristown, New Jersey), etc.).

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

Various types of numerical solution schemes may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

As an example, a scheme may be characterized as adaptive implicit (“AIM”). An AIM scheme may adapt, for example, based on one or more gradients as to one or more variables, properties, etc. of a model. For example, where a model of a subterranean environment includes a region where porosity varies rapidly with respect to one or more physical dimensions (e.g., x, y, or z), a solution for one or more variables in that region may be modeled using an implicit scheme while an overall solution for the model also includes an explicit scheme (e.g., for one or more other regions for the same one or more variables).

As an example, a scheme may be implemented as part of the ECLIPSE 300 reservoir simulator. As an example, the aforementioned OLGA simulator may include an interface that allows for interoperability with an ECLIPSE simulator. The ECLIPSE 300 reservoir simulator may implement a fully implicit scheme or an implicit-explicit scheme that is implicit in pressure and explicit in saturation, known as IMPES. In the fully implicit scheme, values for both pressure and saturation are provided at the end of each simulation time-step; whereas, the IMPES scheme uses saturation values from the beginning of the time-step to solve for pressure values at the end of the time-step. In such examples, a reservoir simulator iterates until pressures values in grid blocks of a model of the reservoir being simulated have reached some internally consistent solution. However, a solution may be difficult to find if saturation (which the IMPES scheme assumes is constant within a time-step) changes rapidly during that time-step (e.g., a large percentage change in grid block values for saturation). The IMPES scheme may be able to cope with such an issue by decreasing “length” (e.g., duration) of the time-step but at the cost of more time-steps (e.g., in an effort to achieve a more stable solution).

The aforementioned fully implicit scheme may be a more stable option with saturation and pressure being obtained simultaneously so as any difference between their values for one time-step and a next time-step does not disturb a solution process as much as when compared to the IMPES scheme. Thus, in a fully implicit scheme, the “length” (e.g., duration) of a time-step may be larger but it also means that the fully implicit scheme may take additional processing time to achieve solutions (e.g., in comparison with an IMPES scheme). However, in a reservoir where properties change rapidly, a fully implicit scheme may provide a solution in less computational time than an IMPES scheme, even though an iteration of the fully implicit scheme may take longer to complete when compared to an iteration of the IMPES scheme.

The aforementioned ECLIPSE 300 reservoir simulator may also implement one or more components such as a black-oil simulator component, a compositional simulator component, or a thermal simulator component (e.g., for simulating thermodynamics, etc.). As an example, a black-oil simulator component may include equations to model three fluid phases (e.g., oil, water, and gas, with gas dissolving in oil and oil vaporizing in gas); as an example, a compositional simulator component may include equations to model phase behavior and compositional changes; and, as an example, a thermal simulator component may include instructions (e.g., for equations, etc.) to model a thermal recovery processes such as steam-assisted gravity drainage (SAGD), cyclic stream operations, in-situ combustion, heater, and cold heavy oil production with sand. As an example, one or more thermal components may provide instructions for modeling and simulating multiple hydrocarbon components in both oil and gas phases, a single nonvolatile component in an oil phase, oil, gas, water, and solids behaviors (e.g., optionally with chemical reactions), well production rates based on factors such as well temperature, low-temperature thermal scenarios (e.g., experiments or cold heavy oil production with sand), toe-to-heel air injection scenarios, foamy oil (e.g., as to effect on gas production, gas drive, oil production, etc.), multi-segmented well models (e.g., optionally including dual-tubing, horizontal wells, multiphase flow effects in a wellbore, etc.).

As to network models, as an example, a method can include simulation of dynamic and/or steady state operation of an oil and gas production system over various ranges of operating conditions and configurations. In such an example, the method may include an implicit evaluation of conservation of energy equations in addition to mass and momentum as an effective technique for efficiently and robustly simulating the production system where, for example, the production system includes fluid such as heavy oil, steam or other fluids at or near critical pressures or temperatures. The term “critical point” may be used herein to specifically denote a vapor-liquid critical point of a material, above which distinct liquid and gas phases do not exist.

As mentioned, a production system can provide for transportation of oil and gas fluids from well locations along flowlines which are interconnected at junctions to combine fluids from many wells for delivery to a processing facility. Along these flowlines (including at one or more ends of a flowline), production equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a production system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a production system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

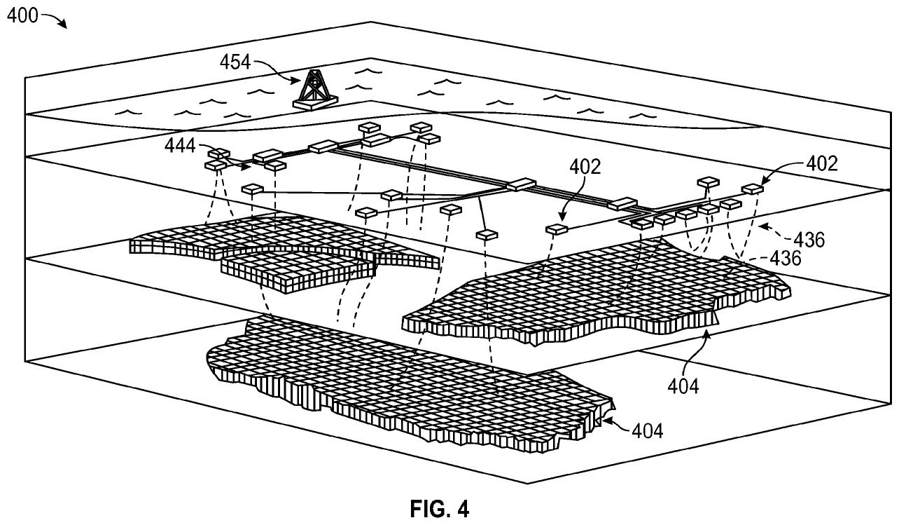

FIG. 4 shows an example of a geologic environment 400 and a system of various types of equipment. As shown, the geologic environment 400 includes a plurality of wellsites 402 operatively connected to a processing facility 454. In the example of FIG. 4, individual wellsites 402 can include equipment that can form individual wellbores 436. Such wellbores can extend through subterranean formations 406 including one or more reservoirs 404. Such reservoirs 404 can include fluids, such as hydrocarbons. As an example, wellsites can draw fluid from one or more reservoirs and pass them to one or more processing facilities via one or more surface networks 444. As an example, a surface network can include tubing and control mechanisms for controlling flow of fluids from a wellsite to a processing facility.

As an example, a method can include executing a computational framework that includes at least one processor for determining composition properties of one or more types of fluids. For example, consider a framework that includes the PVTz analysis software (Schlumberger Limited, Houston, Texas). Such a framework can process laboratory measured PVT data for fluids. For example, such a framework can record fluid phase behavior during PVT lab analyses. As an example, such a framework can be operatively coupled to lab equipment to use position and other types of data (e.g., piston position to compute volumes). Such a framework can perform material balance calculations, equilibrium checks, oil-based mud contamination assessments, etc. As an example, such a framework can perform flash calculations. Such a framework may implement one or more different equations of state (EoSs). As an example, an ECLIPSE simulator compositional simulation E300 flash package may be utilized (e.g., PVTToolbox) to compute densities at various downhole conditions for various fluid types, for example, using the 3-parameter Peng Robinson adjusted EoS or, for example, one or more other EoSs. The Peng Robinson EoS is a cubic EoS for thermodynamic modelling of pressure as a function of temperature and density. For example, a cubic EoS can provide a cubic function of molar volume Vₘ.

As to the Peng Robinson EoS, it aims to provide a framework where parameters can be expressible in terms of critical properties and the acentric factor; the model can provide reasonable accuracy near the critical point, particularly for calculations of the compressibility factor and liquid density; mixing rules can be formulated to not employ more than a single binary interaction parameter, which can be independent of temperature, pressure and composition; and the equation can be applicable to calculations of fluid properties in natural gas processes.

The Peng Robinson EoS may be represented as follows:

$$p = \frac{R T}{{V}_{m} - b} - \frac{a α}{{V}_{m}^{2} + 2 b {V}_{m} - {b}^{2}}$$

$$a \approx 0. 45724 \frac{{R}^{2} {T}_{c}^{2}}{{p}_{c}}$$

$$b \approx 0. 07780 \frac{R {T}_{c}}{{p}_{c}}$$

$$α = {( 1 + κ ( 1 - {T}_{r}^{0.5} ) )}^{2}$$

$$κ \approx 0. 37464 + 1.5226 ω - 0.26992 {ω}^{2}$$

$${T}_{r} = T / {T}_{c}$$

Above, Vₘ is molar volume and the subscript “c” represents critical, and, in polynomial form as function of the compressibility factor Z, the Peng Robinson EoS may be presented as follows:

$$A = \frac{α a p}{{R}^{2} {T}^{2}}$$

$$B = \frac{b p}{R T}$$

$${Z}^{3} - ( 1 - B ) {Z}^{2} + ( A - 2 B - 3 {B}^{2} ) Z - ( A B - {B}^{2} - {B}^{3} ) = 0$$

$$Z = \frac{P V}{n R T}$$

As to some other examples, a method or system may utilize the Redlich Kwong EoS, the Soave modification of the Redlich Kwong (SRK) EoS, the SRK with volume translation of Peneloux (SRK-P), or another EoS formulation. As to the Soave modification of the Redlich Kwong (SRK) EoS, consider the following equations:

$$p = \frac{R T}{{V}_{m} - b} - \frac{a α}{{V}_{m} ( {V}_{m} + b )}$$

$$a \approx 0.42747 \frac{{R}^{2} {T}_{c}^{2}}{{P}_{c}}$$

$$b \approx 0.08664 \frac{R {T}_{c}}{{P}_{c}}$$

$$α = {( 1 + κ ( 1 - {T}_{r}^{0.5} ) )}^{2}$$

$$κ \approx 0.48508 + 1.55171 ω - 0.15613 {ω}^{2}$$

$${T}_{r} = T / {T}_{c}$$

As to the SRK, consider a short-hand representation as follows:

$$p = \frac{R T}{{V}_{m , SRK} - b} - \frac{α}{{V}_{m , SRK} ( {V}_{m , SRK} + b )}$$

$$a = {a}_{c} α$$

$${a}_{c} \approx 0.42747 \frac{{R}^{2} {T}_{c}^{2}}{{P}_{c}}$$

$$b \approx 0. 08664 \frac{R {T}_{c}}{{P}_{c}}$$

As to SRK-P, a factor “c” is introduced, which is a parameter of individual fluid components that can be estimated by a correlation that includes a Rackett compressibility factor (Z_{RA}). For example, consider:

$${c}_{i} \approx 0.40768 \frac{R {T}_{c i}}{{P}_{c i}} ( 0.29441 - 0.29056 - 0.08775 {ω}_{i} )$$

In SRK-P, c can be summed for a number of components and it can be utilized to replace or supplement the factor “b” of SRK (e.g., b replaced by c, a sum of b and c or b minus c).

As to PVT analyses, it can provide output as to how fluids behave within a reservoir, within the wells, at surface conditions, in a conduit network, at a refinery, etc. A method can call for various fluid properties to be estimated or known over a range of temperatures and/or a range of pressures. As an example, when gas is injected into a reservoir, a method can include determining how properties of the original reservoir fluid will change as the composition changes.

PVT analyses as to fluid properties can help with predictions as to one or more of the following: the composition of well stream as a function of time; completion design, which depends on the properties of the wellbore; liquids; whether to inject or re-inject gas, and if so, the detailed specification of the injected gas; how much C3, C4, C5's to leave in; separator configuration and stage for injection gas; miscibility effects that may result from the injected gas; amounts and composition of liquids left behind and their properties: density, surface tension, viscosity, etc.; separator/NGL plant specifications; H₂S and N₂ concentration in produced gas; product values versus time; etc.

As to compositional simulation using a simulator, it can provide output that is improved with respect to black-oil simulation. Composition simulation output can provide improved description of reservoir processes in a number of situations. For example, compositional simulation can assist in Enhanced Oil Recovery (EOR) processes that involves a miscible displacement; cases where gas injection/re-injection into an oil produces a large compositional changes in the fluids; if condensates are recovered using gas cycling (injected gas is substantially different from the composition of free gas in the reservoir); surface facilities detailed compositions of one or more production streams; times and timings; oil production rate(s); etc. Composition simulation can provide insight as to phase behavior; multi-contact miscibility; immiscible or near-miscible displacement behavior in compositionally dependent mechanisms such as vaporization, condensation, and oil swelling; composition-dependent phase properties such as viscosity and density on miscible sweep-out; and interfacial tension (IFT) especially the effect of IFT on residual oil saturation. Such effects can have a substantial effect on production of one or more resources from a reservoir or reservoirs.

In a black-oil approach, a fluid may be fully described by fluid properties in a table of property versus pressure; whereas, in a compositional approach, a solver can be utilized to solve a flash equation and solve an EoS.

With the presence of fluid data from multiple sources (e.g., fluid sampling, production testing, etc.), building one or more EoSs that can comprehensively characterize hydrocarbon fluid at different levels of a production system while honoring measured data can be a considerable challenge, generally involving manual intervention and decision making where, due to a lack of integration, sub-optimal and potentially inconsistent selection of representative EoSs can occur. The lack of consistency may have a substantial impact on a production system and facility design and optimization. Additionally, given the general manual, sequential, and/or iterative nature of such a process, a workflow can be quite slow, for example, too slow for practical demands in meeting real-world project timeframes.

As an example, a system can include one or more features for automation to build consistent EoSs for an integrated reservoir, surface network, and facility. Such a system may automatically build EoSs with different levels of granularity; that is, with different numbers of components and pseudo-components. In such an example, the system may assess the quality of the different EoSs automatically built and calibrated, for example, through modeling measured laboratory data from production testing data that may be acquired from one or more levels of a production system. In such an approach, assessments may result in a ranked set of viable EoSs with appropriate granularity ready to be used in different parts and/or different levels of an integrated production system.

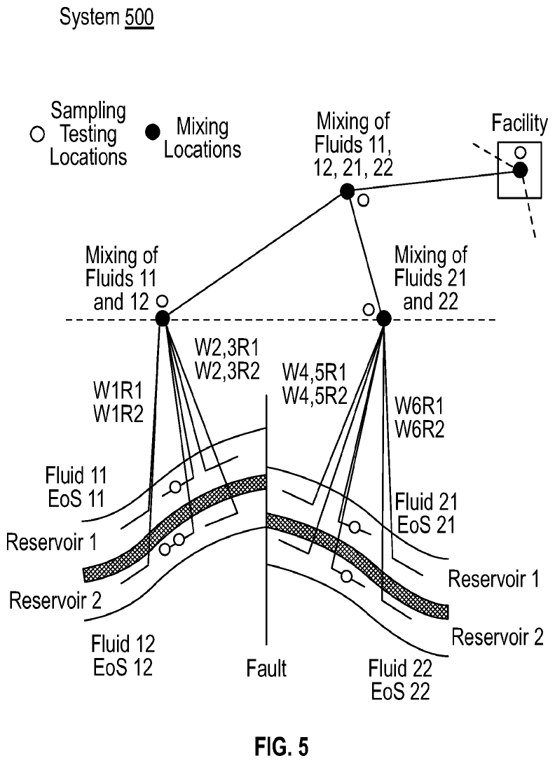

FIG. 5 shows an example of a system 500 that includes equipment that can include downhole equipment, surface equipment (e.g. land and/or marine), etc., which may be part of the system 400 of FIG. 4. In the example of FIG. 5, the system 500 shows a portion of a subsurface environment that includes at least two reservoirs as may be separated by material where a fault may intersect two of the reservoirs, labeled as reservoir 1 and reservoir 2. As shown, wells can be labeled with respect to the reservoirs such as: W1R1, W1R1, W2R1, W3R1, W2R2, W3R2, W4R1, W4R2, W5R1, W5R2, W6R1 and W6R2. In such an example, reservoir 1 is in fluid communication with six wells and reservoir 2 is in fluid communication with six wells. In the example of FIG. 5, some of the wells can be run with sampling equipment such that fluid samples can be acquired. For example, open circles in FIG. 5 indicate sampling sites for wells W2R1, W2R2 (two sites), W5R1 and W5R2. Thus, fluids in the two reservoirs may be characterized via such sampling.

As shown in the example of FIG. 5, due to presence of the fault, the fluid in reservoir 1 and reservoir 2 may differ from one side of the fault to the other side of the fault such that four different types of fluids can exist, labeled as: Fluid 11, Fluid 12, Fluid 21 and Fluid 22. As explained, an EoS can be selected for a particular type of fluid such that the system 500 can utilize four different EoSs for the reservoir fluids. In the example of FIG. 5, the four different EoSs are labeled as: EoS 11, EoS 12, EoS 21, and EoS 22.

In the example of FIG. 5, Fluid 11 and Fluid 12 from the wells W1R1, W1R2, W2R1, W2R2, W3R1 and W3R2 mix at a first surface location and Fluid 21 and Fluid 22 from the wells W4R1, W4R2, W5R1, W5R2, W6R1 and W6R2 mix at a second surface location. As shown, the mixture of Fluid 11 and Fluid 12 from the first surface location and the mixture of Fluid 21 and Fluid 22 from the second surface locations mix at another, third surface location, which is between the first and second surface locations and a surface facility, to provide a mixture of Fluid 11, Fluid 12, Fluid 21 and Fluid 22. In the example of FIG. 5, the facility may receive fluid (e.g., particular fluid(s) and/or mixtures of fluids) in addition to the mixture from the third surface location.

Given the examples of FIG. 2, FIG. 3, FIG. 4 and FIG. 5, various types of equipment that can form one or more systems for movement of fluids where, for example, a framework or frameworks can provide for simulation of one or more physical phenomena utilizing one or more EoSs.

As an example, a system can be characterized by a problem definition. An example of a problem definition is given below:

### Example Problem Definition

### Let

EoSᵢⱼ EoS for Reservoir i, Layer j
EoS_{P} EoS for the network of pipelines
EoS_{F} EoS of the surface Facility
Nᵢⱼ Number of components/Pseudocomponents used in EoSᵢⱼ (Lumped)
N_{P} Number of components/Pseudocomponents used in EoS_{P} (Intermediate)
N_{F} Number of components/Pseudocomponents used in EoS_{F} (Detailed)
Example ordering:
Nᵢⱼ<N_{P}<N_{F}

Different reservoirs in the same reservoir model may use the same number of components and pseudo-components; noting other approaches may be taken, for example, in multiple reservoir coupling scenarios using an integrated asset modeler.

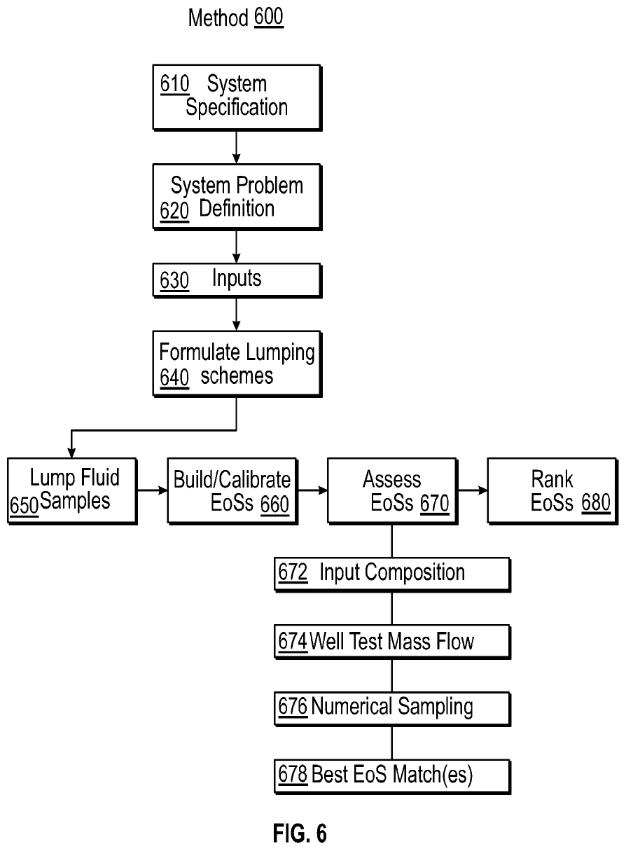

FIG. 6 shows an example of a method 600 that can output one or more EoSs for use by one or more frameworks for modeling one or more systems and/or simulating physical phenomena in one or more systems.

In the example of FIG. 6, the method 600 includes a provision block 610 for providing a system specification, a definition block 620 for defining a system problem (e.g., a system problem definition), a reception block 630 for receiving inputs, and a formulation block 640 for formulating lumping schemes for outputting one or more ranked per an output block 680.

As shown in the example method 600, the formulation block 640 can include a lumping block 650 for lumping fluid samples, a build block 660 for building and calibrating EoSs, an assessment block 670 for assessing the EoSs, and the output block 680 for outputting one or more ranked EoSs.

As shown in the example method 600, the assessment block 670 may include various sub-blocks that may be executed, for example, where composition of a fluid is not available measured through sampling. For example, consider a process that includes a reception block 672 for receiving an input composition, a reception block 674 for receiving well test mass flow information, a sampling block 676 for numerical sampling and an output block 678 for outputting a best match EoS or EoSs.

As an example, the reception block 630 can provide for receiving input such as, for example, hydrocarbon fluid samples from different locations and/or levels of a system. For example, consider receiving samples from bottomhole locations, wellhead locations, inlet to separator locations, etc. As an example, a process can include receiving laboratory analysis results for at least some fluid samples (e.g., consider one or more tests such as constant composition expansion (CCE), constant volume depletion (CVD), differential liberation (DL), etc.). As an example, a process can include receiving production testing results at different locations of a system. For example, consider results such as fluid flash results at a given composition, pressure and temperature.

As an example, the formulation block 640 can include preparing a set (“SET”) of lumping schemes that encompass a spectrum of granularity with regard to a number of component and pseudo-components. In such an example, a process can include utilizing one or more lumping schemes that can accommodate a detailed fluid description that may be used by a facility and a reduced number of components and/or pseudo-components that may be appropriate for reservoir modeling efficiency. As shown in FIG. 6, the formulation block 640 can include sub-blocks for a process where the sub-blocks can include the lumping block 650 for lumping compositions of fluid samples (“SAMPLES”) using a lumping scheme; the build block 660 that can, for each sample in SAMPLES, provide for building and calibrating an EoS where, for example, calibrating may account for a sample's specific laboratory data and/or at least a portion of the SAMPLES' measured laboratory data; the assessment block 670 for assessing the built and calibrated EoSs (e.g., each sample in SAMPLES and/or for each test in production tests (TESTS)); and the output block 680 that can provide for ranking EoSs which can include outputting the EoSs that can match the largest part of laboratory reports and production tests based on one or more predefined criteria.

As shown in the example method 600, the assessment block 670 can include performing a process as may be represented by sub-blocks where a composition of fluid is not available, for example, as measured through sampling. For example, consider the reception block 672 for receiving an input composition for each well, which may be available by using a measured composition of a well and/or a composition from a neighboring well in fluid communication with the same reservoir as the well; the reception block 674 for receiving well test mass flow information, which may involve, using well tests, reconstituting mass flow rate or range of mass flow rates for one or more wells, which may give mass flow rate of each fluid components such that a result may be ranges of mass flow rate for each well; the sampling block 676 for numerical sampling, which can include, for example, using a Monte Carlo sampling technique, etc., that provides for selecting N_{synthetic} combinations of flow rates; noting that, in some embodiments, each of these combinations can constitute numerically the composition at each of a number of nodes of a system tree (e.g., consider the system 500 of FIG. 5 being structured as a tree from the downhole sources to the surface facility); and the output block 678 for outputting a best match EoS or EoSs, for example, that may use each of the N_{synthetic} combinations and select those combinations that provide the best EoS match for the different tests at different nodes of a system (e.g., consider nodes corresponding to surface equipment at the various surface locations in the system 500 of FIG. 5).

Using the system 500 of FIG. 5 as an example, consider the system 500 as including four surface nodes where mixing takes place. In such an example, the composition at each of the nodes depends on mass flow rate from each subordinate node in a tree structure. At the first surface location and the second surface location, mixing occurs for different wells with different hydrocarbon mass flow rates.

As explained, a method such as the example method 600 can provide for preparing consistent EoSs for an overall production system from one or more subsurface locations (e.g., one or more reservoirs) to one or more surface facilities. As explained, a tree structure can be utilized to represent a system where the system can include an end node that receives fluid from various branch and/or leaf nodes. Such a method can help to reduce inconsistencies and hence improve fluid characterization especially at a surface network and a facility side of an integrated system where mixing of different fluid streams takes place.

As explained, a method may be implemented using one or more frameworks that can provide for systematically and automatically building a set of EoS models that are consistent over an entire production system (e.g., or a selected portion of a production system). As an example, a set of existing fluid samples and production testing results may be optimally used in a validation and sorting process to ensure comprehensiveness.

As an example, a method can provide for automation of a modeling process, for example, to be able to efficiently account for a full set of fluid samples and production testing data and, for example, to validate EoSs to available for production tests at a surface facility level and, for example, to automatically prepare and rank a set of EoSs to model an integrated production system.

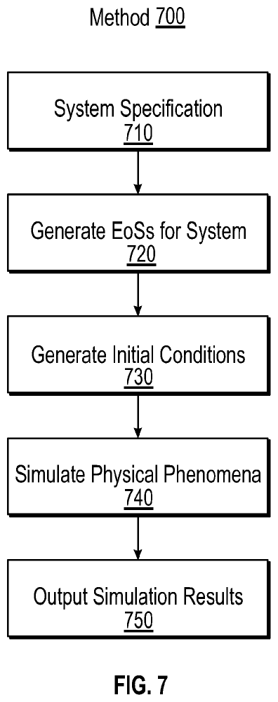

FIG. 7 shows an example of a method 700 that includes a provision block 710 for providing a system specification, a generation block 720 for generating EoSs for the system, a generation block 730 for generating initial conditions, a simulation block 740 for simulating physical phenomena in at least a portion of the system using at least a portion of the EoSs and at least a portion of the initial conditions to generate simulation results, and an output block 750 for outputting at least a portion of the simulation results.

In the example method 700, the generation block 730 can include utilizing one or more trained machine learning models (ML models) to generate initial conditions that can be utilized for performing a simulation. In such an example, the generated initial conditions can improve such a simulation, for example, by improving convergence of such a simulation by utilizing fewer iterations, etc. and/or by increasing chances of arriving at an accurate converged solution (e.g., simulation results).

Reservoir model initialization can include several tasks such as identifying compartments and setting free water level (FWL), gas-oil contact (GOC), and composition in every compartment (e.g., each cell or regions of cells) such that initial conditions in one or more reservoirs honor physics of capillary forces and thermodynamic equilibrium.

In various instances, compositional variation versus depth in a hydrocarbon reservoir can be dictated by the Gibbs condition for thermodynamic equilibrium. The minimum Gibbs energy criterion for equilibrium is a restatement of the second law of thermodynamics, from which it is known that the entropy of a system in equilibrium must be at its maximum, considering the possible states for equilibrium. For example, consider one or more criteria for vapor-liquid equilibria for a system at constant pressure and temperature where the chemical potential of each species is the same in both phases. Such an approach may be generalized to a given number of phases, for which the chemical potential of each species is to be the same in the given number of phases. In such an approach, the chemical potential can be the driving force that moves a species from one phase to the other. As an example, if the chemical potential of a species in one phase is the same as that in the other, there is zero driving force and thus a zero net transfer of species at equilibrium.

Through various phenomena, gravitational forces (pressure diffusion) can compete with molecular (e.g., Fickian) diffusion to establish an equilibrium in a reservoir where, generally, heavy components tend to segregate towards the bottom of a column and light components float towards the top of the column in a relatively continuous way. Fick's first law relates the diffusive flux to the gradient of the concentration. It postulates that the flux goes from regions of high concentration to regions of low concentration, with a magnitude that is proportional to the concentration gradient (spatial derivative), or in simplistic terms the concept that a solute will move from a region of high concentration to a region of low concentration across a concentration gradient. Depending on the composition and reservoir temperature and pressure, a phase change may take place at a certain depth leading to a gas-oil contact (GOC). When collecting samples from a hydrocarbon reservoir, some of the compositional variation can be attributed to compositional variation versus depth and some to compartmentalization.

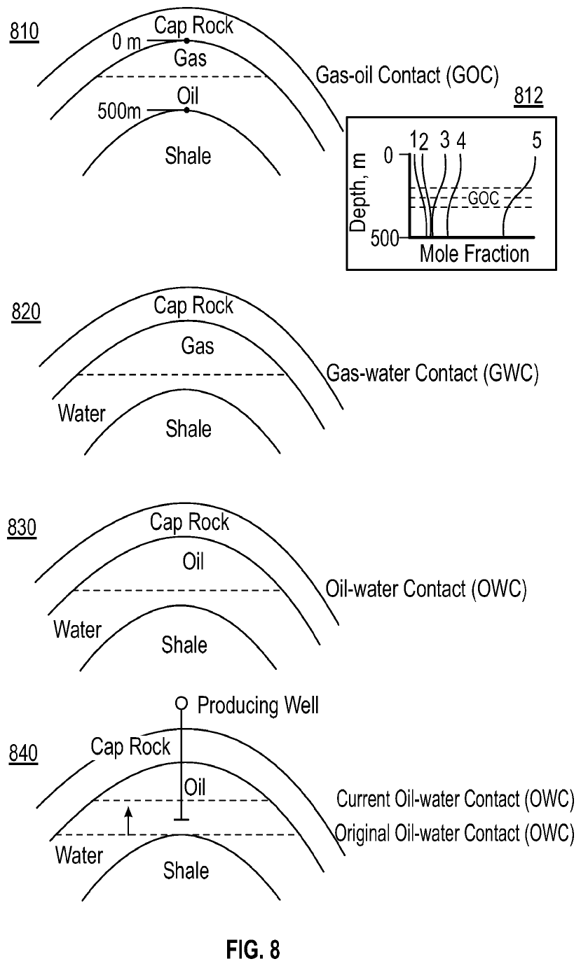

FIG. 8 shows various example scenarios for gas-oil contact 810, gas-water contact 820, oil-water contact 830 and original and current fluid contact 840. As to gas-oil contact (GOC) 810, it can define a bounding surface in a reservoir above which predominantly gas occurs and below which predominantly oil occurs. As gas and oil can be miscible, contact between gas and oil can be transitional, forming a zone containing a mixture of gas and oil. As shown in the scenario 840 of FIG. 8, after some time of production of oil from a reservoir, a location of oil-water contact can rise such that water can be produced (e.g., or more water produced). As explained, as water cut (WC) increases, separation demands at surface may become increasingly costly as the rate of produced oil decreases for a given rate of fluid production. The position of GOC, being the position of the interface between gas and oil phases present in a reservoir formation, can change during a production stage of a well. As explained, the position of GOC may move, resulting in undesirable production conditions such as a high proportion of gas that may be too much for surface processing facilities. Monitoring gas-oil and oil-water contacts can be useful in reservoir management.

The example scenarios of FIG. 8 show fluid being between a layer of shale and a layer of cap rock where the layer of cap rock is arched to form a peak (e.g., a cap). As explained, distribution of fluid can depend on gravity where, for example, a column can be defined that may include heavy components towards the bottom of the column and light components towards the top of the column. In the example scenarios of FIG. 8, the oil and/or the gas may be segregated in a manner that depends on whether they include heavy and/or light components.

In the example for gas-oil contact 810, it can be referred to as a saturated oil reservoir. In such an example, density of hydrocarbon fluid can change with respect to vertical depth such that a gradient in density exists from relatively heavier at larger vertical depths and relatively lighter at smaller vertical depths. In such an example, an instability can exist at a vertical depth, due to liquid (oil) being thermodynamically unstable, such that, above that vertical depth, vapor (gas) exists (e.g., due to gravity and molecular diffusion).

In the example of FIG. 8, an example plot 812 of depth in meters versus mole fraction of five example components is shown where the depth axis runs downwardly from 0 meters to 500 meters. Such a plot can be a compositional gradient plot or a compositional variation with respect to depth plot. In the example of FIG. 8, the fluid space is taken to be 500 meters, which can be referred to as a reservoir interval where, over that interval, the reservoir includes an oil portion and a gas portion. As an example, a plot such as the plot 812 may be generated for an entire interval and/or for a portion of an entire interval (e.g., a gas portion, an oil portion, etc.). As an example, where a sample location is known for a reservoir fluid sample, it may be assumed to have a composition that lies along a composition gradient; however, as a boundary or boundaries may be unknown (e.g., whether rock or fluid), various types of uncertainty can exist as to how the sample relates to a compositional gradient.

In the example for gas-water contact 820, it can be referred to as a gas reservoir. As shown, in the example for oil-water contact 830, it can be referred to as an under-saturated oil reservoir. As mentioned, in the example for original and current fluid contact 840, it can represent a scenario that pertains to evolution of a reservoir over time, for example, due to production (e.g., drainage of hydrocarbon fluid from the reservoir).

As an example, a simulation may aim to simulate various physical phenomena to understand when and/or how a change in position of contact may occur (e.g., between two phases, types of fluids, etc.). In such an example, equipment may be controlled in a manner that can more favorably produce a desired resource from a reservoir or reservoirs.

As an example, fluid types may include, for example, from light to heavy, dry gas, wet gas, gas condensate, volatile oil, black-oil, heavy oil, super heavy oil, and asphaltene (e.g., DG, WG, CG, VO, BO, HO, SHO, ASP, respectively). In such example fluid types, each type may include a composition of components where at least some of the components may be characterized based on how many carbon atoms are in each component (e.g., from light carbon components such as methane (CH4) to heavier long chain and/or aromatic carbon components).

Whether a component is in a liquid state or gas state can depend on various conditions, including pressure and temperature. As to types of contact, one or more of the example scenarios 810, 820, 830 and 840 of FIG. 8 may be considered and/or may exist in one or more reservoirs.

As an example, a method can include generating compositional variations with respect to depth (e.g., vertical depth) for one or more reservoirs where such compositional variations may be utilized for setting initial conditions for a simulator or simulators. As an example, a simulation may generate results such as those of the example scenario 840 of FIG. 8 where original and current fluid contacts are shown. As an example, simulation results can show compositional variation changes from an original time (e.g., an initial time) to a current time (e.g., a simulation time). In such an example, a simulation can include utilizing one or more appropriate EoSs and appropriate initial conditions, which may both be determined automatically in a manner where EoSs are consistent and where initial conditions can promote enhanced convergence to a solution.

As an example, a framework can include features for combining thermodynamics and machine learning (ML) to predict compositional variation versus depth and/or segregate, as feasible, compositional variation associated to depth, which can be, for example, associated with compartmentalization. Such an approach can contribute to a drastically more consistent and efficient initialization in a reservoir model that honors thermodynamics and addresses the uncertainty in reservoir fluid (PVT) data.

As an example, a method can involve selecting multiple EoS models and/or initial reservoir conditions for a specific field/reservoir with available PVT data covering a suitable range of variation in areal or vertical composition. Such a method may result in a set of initialization scenarios that can be directly used in dynamic simulation and capable of uncertainty assessment with regard to volumes initially in-place and production forecasting.

As explained, a framework can provide for combined ML and thermodynamics to predict compositional variation versus depth under uncertainty of available PVT data. In such an example, the framework can support EoS modeling and model initialization with regard to GOC in saturated oil reservoirs. As an example, an approach can provide for identifying PVT samples that may be, within a certain tolerance, predicted through compositional variation versus depth (CVVD) and/or may identify parameters that can embed and recognize compositional variation versus depth in a ML process that can train one or more ML models where a trained ML model or models can be utilized to make predictions.

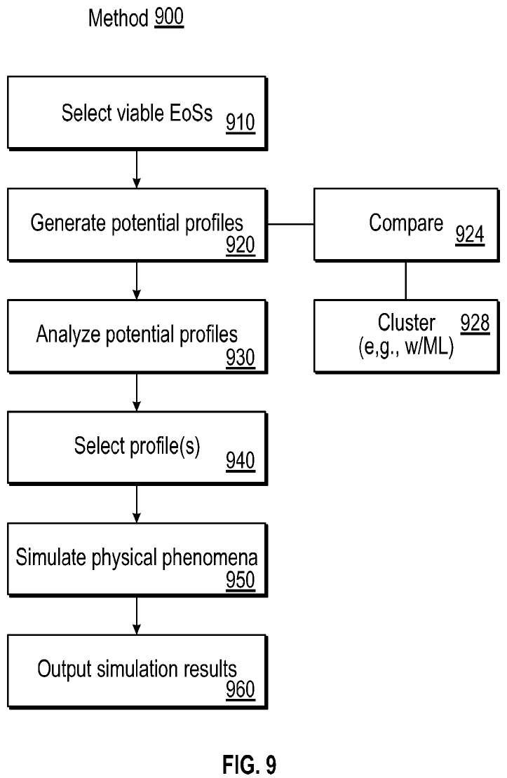

FIG. 9 shows an example of a method 900 that includes an automation block 910 for automatically selecting a set of viable EoSs for a given reservoir (see, e.g., the method 600 of FIG. 6); an automation block 920 for automatically generating a list of potential compositional variation versus depth profiles from available samples, for example, per a comparison block 924 for comparing results and identifying ranges of variability and/or per a clustering block 928 for clustering and implementing a trained ML model to help narrowing down uncertainty by identifying apparent compartments and assessing composition variability within each compartment; an analysis block 930 for analyzing the potential profiles; a selection block 940 for selecting one or more of the potential profiles; a simulation block 950 for simulating physical phenomena using at least one of the selected one or more potential profiles (e.g., for initial condition(s)) to generate simulation results; and an output block 960 for outputting at least a portion of the simulation results.

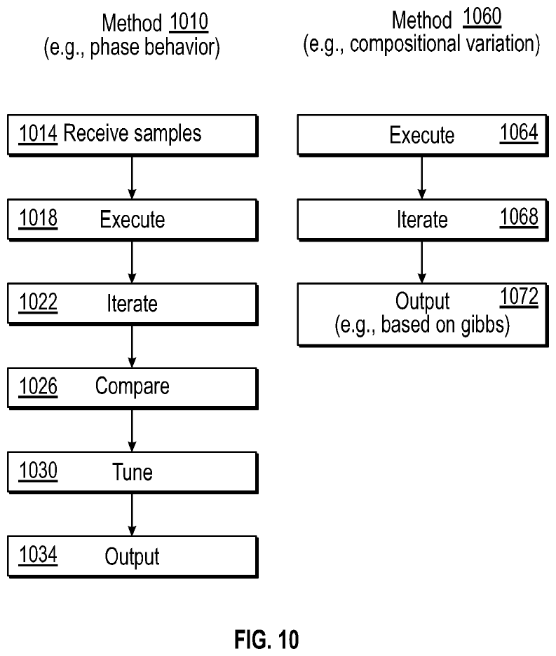

FIG. 10 shows example methods 1010 and 1060 that can correspond to framework features of a framework that can output information suitable for use in setting initial conditions for a simulation of physical phenomena.

As shown, the method 1010 can account for phase behavior, for example, with respect to one or more EoSs. As shown, the method 1010 can include a reception block 1014 for receiving SAMPLES and storing data according to a suitable data structure; an execution block 1018 for executing a batch mode with respect to the SAMPLES; an iteration block 1022 for iterating through a suitably large number of data sets (SAMPLES); a comparison block 1026 for comparing EoS model results to laboratory results (EXPERIMENTS); a tuning block 1030 for tuning (e.g., via regression, etc.) based on a prescribed set of tuning parameters; and an output block 1034 for outputting results. In such an example, the results can include one or more tuned EoS models for one or more reservoirs. In the example method 1010 of FIG. 10, such EoS models can be calibrated or regressed such that they are suitable for use in one or more simulation frameworks (e.g., ECLIPSE, INTERSECT, PIPESIM, OLGA, etc.). As explained samples (SAMPLES) can be for one or more bottomhole conditions, one or more surface conditions, etc.

As to the method 1060, it can provide for generation of compositional variation information, for example, with respect to one or more spatial dimensions (e.g., depth, etc.). As an example, the method 1060 may utilize a Gibbs criterion for thermodynamic equilibrium. As shown, the method 1060 includes an execution block 1064 for execution in a batch mode, optionally automatically; an iteration block 1068 for iterating through a suitably large number of data sets (SAMPLES); and an output block 1072 for outputting results, which, as mentioned, can be based at least in part on the Gibbs criterion for thermodynamic equilibrium. In the example method 1060 of FIG. 10, the results can include one or more sets of initialization values for initialization of one or more reservoir models for use in one or more simulation frameworks (e.g., ECLIPSE, INTERSECT, PIPESIME, OLGA, etc.).

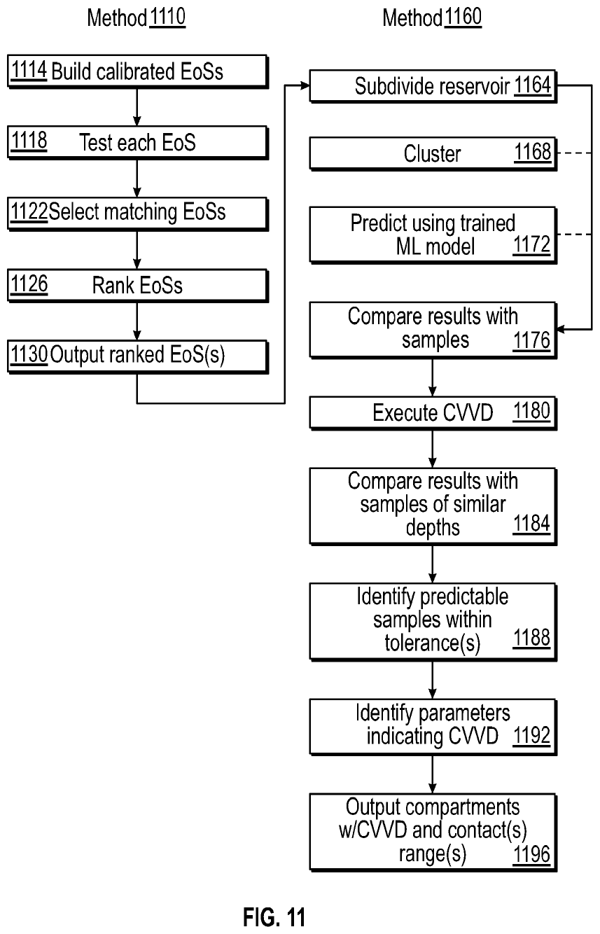

FIG. 11 shows an example method 1100 that can be implemented using an example method 1110 and/or an example method 1160 where the examples methods 1110 and 1160 may be operatively coupled.

As shown the example method 1110 can include a build block 1114 for building calibrated EoSs (e.g., tuned EoSs such as per the method 1010 of FIG. 10), a test block 1118 for testing each of the calibrated EoSs, a selection block 1122 for selecting matching EoSs, a rank block 1126 for ranking EoSs, and an output block 1130 for outputting one or more ranked EoSs.

In the example method 1110, the build block 1114 can provide for building a calibrated EoS for each sample in a PVT samples database for a target reservoir or target reservoirs. In the example method 1110, the test block 1118 can include generating simulated data (e.g., simulated laboratory data) using an EoS to provide for modeled results for comparing modeled results to laboratory data. While laboratory data are mentioned, such data can be or include field data acquired via appropriate field equipment, which may be assessed at a field site (e.g., a wellhead at surface, via downhole equipment, a wireline truck, etc.). The test block 1118 can generate matching metrics that indicate how closely modeled results match laboratory data. As an example, an approach to matching may utilize phase information (e.g., PVT information, phase plots, etc.).

In the example method 1110, the selection block 1122 can utilize one or more matching metrics to select various EoSs for each PVT sample, for example, within an acceptable prescribed range (e.g., predefined, user adjustable, etc.). As to the ranking block 1126, as mentioned, it can provide for ranking EoSs as selected according to one or more criteria (e.g., prescribed range, tolerances, etc.). In such an example, the ranking block 1126 may provide for selecting a set of EoSs that are capable of matching a largest set of PVT samples within a reservoir or reservoirs.

As shown in FIG. 11, the method 1110 can output, per the output block 1130, appropriate EoSs that can be utilized, for example, by the method 1160 for purposes of providing EoSs and corresponding initial conditions (e.g., initial compositions with respect to depth, etc.) for modeling one or more hydrocarbon reservoirs, which may be within a system that can include one or more surface networks.

As shown in FIG. 11, the method 1160 can include a subdivision block 1164 for subdividing a reservoir interval into windows (e.g., depth windows). For example, consider a reservoir interval of 500 meters that is divided into 10 windows of 50 meters each. In such an approach, the number of windows and/or sizing of the windows can depend on one or more factors such as, for example, type of reservoir, reservoir thickness, etc.

In the example method 1160, a comparison block 1176 can provide for comparing PVT samples with modelled results for the windows and/or the reservoir interval. For example, the comparison block 1176 may implement one or more techniques such as, for example, clustering per a cluster block 1168, prediction per a prediction block 1172 and/or one or more other techniques. In such an approach, the method 1160 may perform clustering on PVT samples on a reservoir interval, a prescribed depth window, etc., which can provide for identifying potential compartmentalization of a reservoir over the reservoir interval and/or provide for reducing computational demands when generating initial conditions.

As shown in the example method 1160, the prediction block 1172 may implement one or more trained machine learning (ML) models (e.g., for prediction, classification, etc.). For example, consider using a trained ML model to predict composition of a specific sample on a depth window (e.g., for one or more PVT samples belonging to a depth window). In such an example, predictions and/or classifications from a trained ML model (or ML models) can be for one or more of suitable depth windows. Such an approach can provide for predicted compositional variation for at least a portion of the reservoir interval and may optionally provide for prediction of compositional variation of an entire reservoir interval using information from samples. For example, information from a sample may be input to a trained ML model that can output a prediction for that sample where the prediction can be a compositional gradient with respect to depth for a particular depth window.

As explained, the comparison block 1176 can provide for comparing results using a clustering technique per the block 1168, a trained ML model per the block 1172, etc., to samples that may span an entire reservoir interval such that the entire reservoir interval can be characterized, including, for example, compartmentalization, if present. In the comparison block 1176, quality of clustering, predictions, etc., can be compared to samples to characterize a reservoir interval. Once characterized, the method 1160 can include performing various actions to further characterize the reservoir interval for purposes of generating initial conditions for the reservoir interval.

As to compartmentalization, a compartment may be a productive segment of an oil or gas field that is not in fluid communication with one or more other portions of a field. As an example, a productive compartment or productive compartments may become isolated at the time of accumulation by depositional processes or become isolated after deposition and burial by diagenesis or by structural changes, such as faulting. As an example, production and/or injection may cause phenomena that may lead to some amount of compartmentalization. As an example, a field that is compartmentalized may be developed using a number of wells where, for example, various compartments can be in fluid communication with one or more wellbores. As an example, each compartment may have its own fluid composition (see, e.g., FIG. 8), which can be associated with a particular EoS and compositional variation with respect to depth (e.g., initial conditions, etc.).

Compartmentalization can be described as segregation of a hydrocarbon accumulation into a number of individual fluid/pressure compartments, which can occur when flow is prevented across sealed boundaries in a reservoir. Such boundaries may be the result of one or more of a variety of geological and fluid dynamic factors (e.g., consider static seals and dynamic seals). Reservoir compartmentalization can impact the volume of moveable (e.g., producible) oil or gas that might be connected to a given well drilled in a field. Proper characterization of compartmentalization, if present, can facilitate simulation and, for example, generation of estimates as to producible hydrocarbons.

As to training a ML model, consider using a database of samples from various reservoirs where compositional gradient (e.g., compositional variation with respect to depth) has been established. In such an example, the ML model may be a pattern based model that can predict a compositional gradient as a pattern associated with a sample. For example, consider accessing data that is described with respect to gravity and/or one or more boundaries (e.g., rock boundaries, fluid boundaries, etc.). In such an example, a compositional gradient can be described with respect to gravity and/or one or more boundaries such that a depth window can be utilized.

As an example, a compositional gradient can be represented as a pattern with respect to a linear dimension that can be equated to depth as in a depth window (see, e.g., the plot 812 of FIG. 8). For example, a compositional gradient can be represented in two dimensions where one dimension corresponds to depth and another dimension corresponds to an amount of a component such as, for example, mole fraction, mass fraction, etc. In such an example, a database of two dimensional information (e.g., optionally images) can be utilized to train a ML model such that sample information can be input and a compositional gradient output. As explained with respect to the plot 812 of FIG. 8, such a type of plot can correspond to an entire interval (e.g., 0 m to 500 m) or to less than an entire interval, optionally with one or more boundaries specified (e.g., rock and/or fluid).

With reference to the plot 812 of FIG. 8, a sample can include information as to composition of the sample such that for the five components in the plot 812, the sample will include five points that can correspond to a known depth of the sample. In such an approach, the five points of the sample can be input to a trained ML model where the trained ML model predicts a compositional gradient by matching the five points to a suitable pattern where the pattern represents a compositional gradient. As an example, a method can include inputting information for a number of samples into a trained ML model where the trained ML model predicts a compositional gradient using the information. As explained, an input parameter to a trained ML model can include a depth window and/or one or more boundaries (e.g., rock and/or fluid). In such an example, where sample information corresponds to multiple depths, a depth window may be increased in comparison to sample information at a single depth. As an example, where sample information corresponds to multiple depths where the depths may be in different fluid layers (e.g., oil and gas), an input parameter to a trained ML model can include an indication of a fluid boundary (e.g., contact).

As explained, a method can include using a trained ML model to predict one or more compositional gradients for at least a portion of a reservoir interval such as a depth window or depth windows. In such an approach, a number of predicted compositional gradients may be combined with respect to depth to estimate a compositional gradient for a larger span of a reservoir interval. Such a larger span may be assessed using one or more metrics such as, for example, one or more continuity metrics, which may discern quality of individual predictions and/or one or more boundaries (e.g., rock and/or fluid). For example, as explained with respect to FIG. 8, a boundary can be a rock boundary (e.g., shale, cap rock, etc.) or a fluid boundary (e.g., a type of contact).

In the example of FIG. 8, the scale of the cap rock with respect to its curvature may be hundreds of meters or more across such that more than one well may be in fluid communication with the reservoir. In such an example, a sample from one well may be comparable to a sample from another well, whether at the same depth or at another depth. Whether samples include samples from the oil layer and the gas layer or multiple oil layer samples and/or multiple gas layer samples, such samples may be utilized in a method to generate one or more compositional gradients.

As an example, field operations may provide a number of samples such as 100 samples with different depth or window of depth (e.g., 10 meters). In such an approach, each sample may be utilized as input to a trained ML model (e.g., for fluid, for liquid, for gas, etc.), to output a compositional gradient for a window. In such an approach, a number of compositional gradients can be generated and pieced together to estimate a composition gradient over a larger depth span. As explained, the comparison block 1176 can include comparing results such as an estimated compositional gradient over a large depth span of a reservoir to samples where an acceptable estimation compares favorably to the samples (e.g., the samples correspond to a suitable, physically meaningful compositional gradient).

As explained, the method 1160 can provide for generation of initial conditions for a reservoir interval where the reservoir interval has been subdivided into windows (e.g., depth windows) and with corresponding determined compositional variations. As mentioned, the method 1160 can also provide for indications of compartmentalization where, for example, each compartment may be subdivided and characterized with corresponding determined compositional variations.

As shown in the example method 1160 of FIG. 11, an execution block 1180 can provide for executing a compositional variation versus depth (CVVD) application that can generate compositional variation versus depth for the reservoir interval, for example, using a Gibbs thermodynamic equilibrium approach. In such an example, the CVVD application can utilize information from the samples (e.g., sample information), which, as mentioned, may be clustered (e.g., to reduce complexity, etc.). As explained, a CVVD application can utilize a Gibbs approach where, for example, results may be obtained for each of the samples, a reduced number of the samples and/or for each of a number of clusters. For example, the method 1160 can utilize the block 1176 in a manner that can increase confidence (e.g., reduce uncertainty) in the utilization of the CVVD application and further processes. As explained, the comparison block 1176 can generate information that may be utilized to retain and/or discard one or more samples from a group of samples (e.g., via comparisons, clustering, etc.) and/or to reduce number of samples via clustering to provide sample centroids, etc., that adequately represent information from a larger number of samples.

In a comparison block 1184, the method 1160 can include comparing results from the CVVD application to the results for the windows and/or to samples (e.g., sample information) from corresponding and/or similar depths (e.g., comparing data with CVVD results).

In an identification block 1188, the method 1160 can include identifying samples that can be, within a certain predefined tolerance, predicted through results of the CVVD application. In such an approach, at least some samples can be characterized as suitably fitting the CVVD application results or not.

In an identification block 1192, the method 1160 can include identifying, as feasible, through sensitivity analysis (e.g., on a ML model and/or a clustering technique), parameters that can embed and recognize compositional variation versus depth. In such an example, feedback may be provided to a machine learning process, for example, as to hyper-parameter tuning, data selection, data preparation, etc., such that a ML model can be improved. Further, in such an example, predictions from one or more techniques and one or more estimations from the CVVD application may be compared to discern and/or reduce uncertainty as to compositional gradient(s) and/or boundaries (e.g., rock and/or fluid), which may include determinations as to compartmentalization.

In the example method 1160, the output block 1196 can output compartments, as appropriate, along with compositional variation with respect to depth and a range or ranges of one or more types of fluid boundaries (see, e.g., FIG. 8). For example, consider output that includes a most likely number of areal compartments and/or vertical compartments with a set of potential compositional variations with respect to depth and a positional range of GOC (e.g., and/or other contact(s)) in each of the one or more compartments. As explained, such output may be utilized in an initialization process for reservoir simulation, which may be in a larger simulation that includes one or more surface networks, etc.

As an example, one or more simulation frameworks may include and/or be operatively coupled to a framework that can perform the method 1110 and/or the method 1160 of FIG. 11.

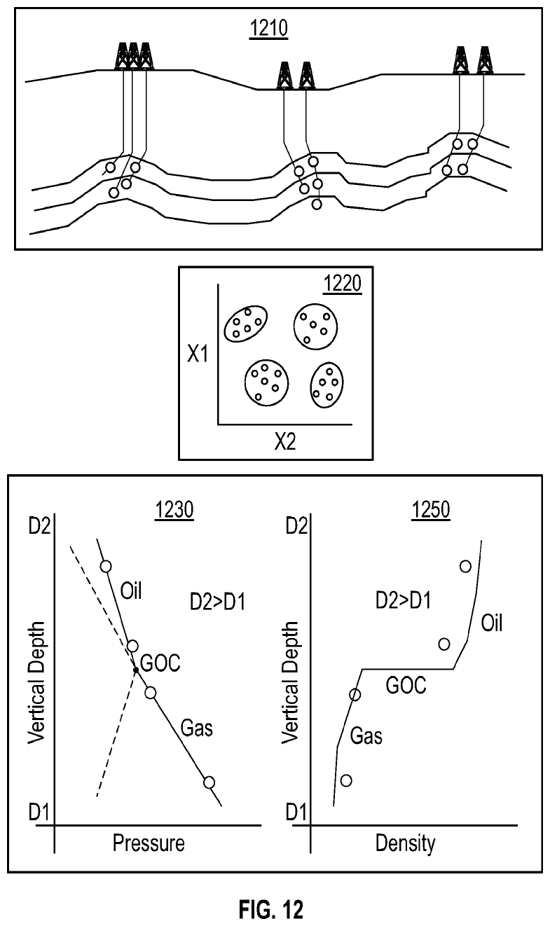

FIG. 12 shows an example of a system 1210, an example of clustering 1220, and example plots 1230 and 1250. As explained, one or more techniques (e.g., clustering, utilization of a trained ML model (or ML models), etc.) can narrow down uncertainty by helping to identify apparent compartments and assessing composition variability within each compartment.

As shown in FIG. 12, the system 1210 can include a number of wells where samples of reservoir fluid can be acquired from one or more reservoirs. In the clustering example 1220, an approach can define clusters in one or more dimensions where, as show, four clusters may be identified. In such an example, a method can include utilizing centroids of the clusters for purposes of generation of initial conditions and/or other information. As to a clustering technique, consider, for example, a k-means clustering technique where k can be a parameter that can be tuned to arrive at a suitable number of clusters (e.g., k clusters). As an example, where contact exists, a clustering technique may aim to provide a number of clusters on each side of the contact (e.g., one or more gas clusters and one or more oil clusters). Such an approach can help to assure that a location of contact may be more readily estimated (see, e.g., the plots 1230 and 1250).

As to the plot 1230, it shows vertical depth versus pressure where gas and oil phases are identified along with a gas-oil contact point (GOC) while the plot 1250 shows vertical depth versus density. As shown, in the plot 1230, the solid line is pressure, which changes slope due to density, whereas the dashed line is the saturation pressure, with below the GOC, is bubble point pressure and, above the GOC, is the dew point pressure. The plot 1230 can correspond to a light component (e.g., or a light cluster as a mixture of components); noting that a heavier component (e.g., or a heavier cluster as a mixture of components) may have a different shape (see, e.g., the plot 812 of FIG. 8). In such an approach, slopes may be utilized to locate a vertical depth and/or a range of vertical depths for contact (e.g., GOC, etc.).

As explained, in the presence of multiple PVT samples in a reservoir, a method such as, for example, the method 700 of FIG. 7, can provide for improved production forecasting. As an example, a method can include assessing a group of EoSs and ranking the most representative EoSs. As explained, such a method can include reducing uncertainty in compositional variation with respect to depth, particularly where compartmentalization exists.

As an example, a method can provide for one or more of dynamic reservoir simulation (e.g., initialization, etc.), compartmentalization analysis in a hydrocarbon reservoir, and bottomhole sampling optimization during an openhole sampling operation.

As explained, one or more frameworks can provide for simulation of physical phenomena. For reservoir simulation, a simulator can be loaded with selections as to one or more EoSs and initial conditions. For example, consider a framework such as the PETREL framework as including features as in the blocks 720 and 730 of the example method 700 for automated EoS selection and initialization (e.g., setting of initial conditions, etc.) of one or more reservoir models, one or more surface networks, etc., suitable for use in one or more reservoir simulation frameworks, one or more surface network simulation frameworks, etc. In such an example, the framework may utilize an automated approach, which may supplement or supplant existing PVT modeling applications such as, for example, the PVTi application (Schlumberger Limited, Houston, Texas), the FLUIDMODELER application (Schlumberger Limited, Houston, Texas), etc.

The PVTi application provides for estimation of fluid properties and exporting PVT tables (e.g., suitable for the ECLIPSE simulator). As explained, a model can utilize a grid that adheres to geometry (e.g., from seismic surveys, etc.) along with property data to form a geocellular model, which can be initialized using a PVT model (e.g., PVT information to populate cells parameters of the geocellular model). Such a model can then be received by a reservoir simulator to generate simulation results, which may be compared against production history and/or well test data (e.g., history matching, etc.). PVT tables can include properties of reservoir rocks and fluids as a function of fluid pressure. Specifically, the PVTi application includes a compositional PVT EoS for characterizing a set of fluid samples for generation of PVT tables where the fluid samples aim to provide a more realistic starting point for reservoir simulation. As explained, an EoS can relate pressure to volume and temperature (e.g., PVT EoS). The PVTi application can be utilized to match an EoS to an observation (e.g., one or more fluid samples), for example, to create black oil PVT tables for a black oil model or compositional PVT parameters for a compositional model. In various instances, phase plots may be utilized, for example, consider a pressure versus temperature phase plot for one or more samples, etc. As an example, finger plots, ternary plots, etc. may be utilized. Various phase plots can include information as to bubble point pressure, dew point pressure, critical point (e.g., critical temperature and/or pressure), etc.

Approaches that utilize particular applications involve manual interactions. For example, the PVTi application can provide for manual interactions between a user and a computing system for viewing phase plots, EoS-based simulations, making comparisons between EoS simulations and sample data. A fluid model can be manually edited, for example, to select an EoS, components, binary interaction coefficients, volume shifts, thermal properties viscosity coefficients, etc. As to EoS selection, PVTi can include the 2 parameter Peng Robinson (PR) EoS, the 2 parameter Soave Redlich Kwong (SRK) EoS, the Redlich Kwong (RK) EoS, the Zudkevitch Joffe (ZJ) EoS, the 3 parameter Peng Robinson (PR) EoS, the 3 parameter Soave Redlich Kwong (SRK) EoS, the Schmidt Wenzel (SW) EoS, etc., along with various viscosity correlation types (e.g., Lohrenz Bray Clark, Pedersen, Aasberg Peterson, etc.). An application such as the PVTi application can include performing regression on EoS parameters, for example, where a fluid description is incomplete, issues exist for an EoS, etc., where various regression variables may be selected manually. As an example, regression may be utilized to fit an EoS using a fluid model.

As explained, various existing applications demand considerable manual interaction to generate PVT data for purposes of simulation. Such a process can be referred to as tuning an EoS to measured data (e.g., observations such as samples). As a simulation can take a considerable amount of time and computational resources, where an issue exists in setting up the simulation (e.g., due to poor simulation results, a failure to converge, etc.), a user has to iterate back to such an existing manual application in an effort to generate a better EoS or EoS choices and/or initial conditions (e.g., compositional variation versus depth, etc.).

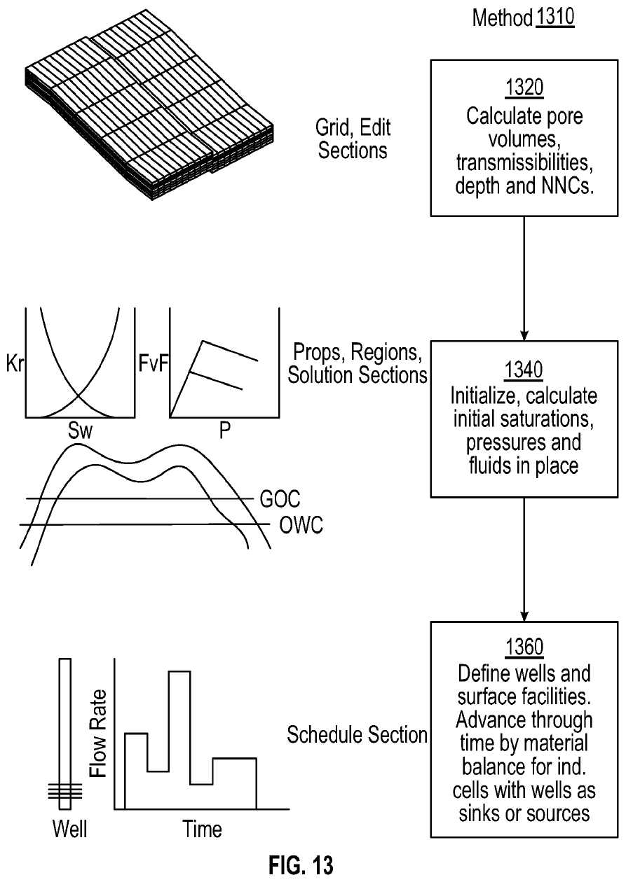

FIG. 13 shows an example of a method 1310 that includes a calculation block 1320 for calculating pore volumes, transmissibilities, depths and non-neighbor connections (NNCs), an initialization and calculation block 1340 for initializing and calculating initial saturations, pressure and fluids in place (e.g., reserves, etc.), and a definition and time progression block 1360 for defining one or more wells and surface facilities and advancing through time, for example, via material balances for individual cells (e.g., with the one or more wells as individual sinks and/or sources).

As to the initialization and calculation block 1340, for an initial time (e.g., to), saturation distribution within a grid model of a geologic environment and pressure distribution within the grid model of the geologic environment may be set to represent an equilibrium state (e.g., a static state or “no-flow” state), for example, with respect to gravity. In the example of FIG. 13, various example plots are shown such as, for example, a spatial plot of gas-oil contact (GOC) and oil-water contact (OWC).

Initialization aims to define fluid saturations in individual cells such that a “system” being modeled is in an equilibrium state (e.g., where no external forces other than gravity are applied, no fluid flow is to take place in a reservoir, a condition that may not be obeyed in practice). As an example, consider oil-water contact (OWC) and assume no transition zone, for example, where water saturation is unity below an oil-water contact and at connate water saturation above the contact. In such an example, grid cells that include oil-water contact may pose some challenges. A cell (e.g., or grid cell) may represent a point or points in space for purposes of simulating a geologic environment. Where an individual cell represents a volume and where that individual cell includes, for example, a center point for definition of properties, within the volume of that individual cell, the properties may be constant (e.g., without variation within the volume). In such an example, that individual cell includes one value per property, for example, one value for water saturation. As an example, an initialization process can include selecting a value for individual properties of individual cells.

As an example, an initialization of water saturation may be performed using information as to oil-water contact. For example, for a cell that is below oil-water contact, a water saturation value for that cell may be set to unity (i.e., as water is the more dense phase, it is below the oil-water contact); and for a cell that is above oil-water contact, a water saturation value for that cell may be set to null (i.e., as oil is the lighter phase, it exists above water and hence is assumed to be free of water). Thus, in such an example, where at least some information as to spatially distributed depths of oil-water contact may be known, an initialized grid cell model may include cells with values of unity and cells with values of zero for water saturation.

As mentioned, a reservoir simulator may advance in time. As an example, a numeric solver may be implemented that can generate a solution for individual time increments (e.g., points in time). As an example, a solver may implement an implicit solution scheme and/or an explicit solution scheme, noting that an implicit solution scheme may allow for larger time increments than an explicit scheme. Times at which a solution is desired may be set forth in a “schedule”. For example, a schedule may include smaller time increments for an earlier period of time followed by larger time increments.

A solver may implement one or more techniques to help assure stability, convergence, accuracy, etc. For example, when advancing a solution in time, a solver may implement sub-increments of time, however, an increase in the number of time increments can increase computation time. As an example, an adjustable increment size may be used, for example, based on information of one or more previous increments.

As an example, a simulator may implement an adjustable grid (or mesh) approach to help with stability, convergence, accuracy, etc. For example, when advancing a solution in time, a solver may implement grid refinement in a region where behavior may be changing, where a change in conditions exists/occurs, etc. For example, where a spatial gradient of a variable exceeds a threshold spatial gradient value, a re-gridding may be implement that refines the grid in the region by making grid cells smaller.

Adaptive gridding can help to decrease computational times of a simulator. Such a simulator may account for one or more types of physical phenomena, which can include concentrations, reactions, micelle formations, phase changes, thermal effects (e.g., introduction of heat energy, heat generated via reactions, heat consumed via reactions, etc.), momentum effects, pressure effects, etc. As an example, physical phenomena can be coupled via a system of equations of a simulator. One or more types of physical phenomena may be a trigger for adaptive gridding.

As an example, a numeric solver may implement one or more of a finite difference approach, a finite element approach, a finite volume approach, a point-based approach, etc. As an example, the ECLIPSE reservoir simulator can implement central differences for spatial approximation and forward differences in time. As an example, a matrix that represents grid cells and associated equations may be sparse, diagonally banded and blocked as well as include off-diagonal entries.

As an example, a solver may implement an implicit pressure, explicit saturation (IMPES) scheme. Such a scheme may be considered to be an intermediate form of explicit and implicit techniques. In an IMPES scheme, saturations are updated explicitly while pressure is solved implicitly.

As to conservation of mass, saturation values (e.g., for water, gas and oil) in individual cells of a grid cell model may be specified to sum to unity, which may be considered a control criterion for mass conservation. In such an example, where the sum of saturations is not sufficiently close to unity, a process may be iterated until convergence is deemed satisfactory (e.g., according to one or more convergence criteria). As governing equations tend to be non-linear (e.g., compositional, black oil, etc.), a Newton-Raphson type of technique may be implemented, which includes determining derivatives, iterations, etc. For example, a solution may be found by iterating according to the Newton-Raphson scheme where such iterations may be referred to as non-linear iterations, Newton iterations or outer iterations. Where one or more error criteria are fulfilled, the solution procedure has converged, and a converged solution has been found. Thus, within a Newton iteration, a linear problem is solved by performing a number of linear iterations, which may be referred to as inner iterations.

As an example, a solution scheme may be represented by the following pseudo-algorithm:

```
// Pseudo-algorithm for Newton-Raphson for systems
initialize(v);
do {
  //Non-linear iterations
  formulate_non_linear_system(v);
  make_total_differential(v);
  do {
    // Linear iterations:
    update_linear_system_variables(v);
  }
  while((linear_system_has_not_converged(v));
  update_non_linear_system_after_linear_convergence(v);
}
while((non_linear_system_has_not_converged(v))
```

As an example, a solver may perform a number of inner iterations (e.g., linear) and a number of outer iterations (e.g., non-linear). As an example, a number of inner iterations may be of the order of about 10 to about 20 within an outer iteration while a number of outer iterations may be about ten or less for an individual time increment.

As mentioned, fluid saturation values can indicate how fluids may be distributed spatially in a grid model of a reservoir. For example, a simulation may be run that computes values for fluid saturation parameters (e.g., at least some of which are “unknown” parameters) as well as values for one or more other parameters (e.g., pressure, etc.).

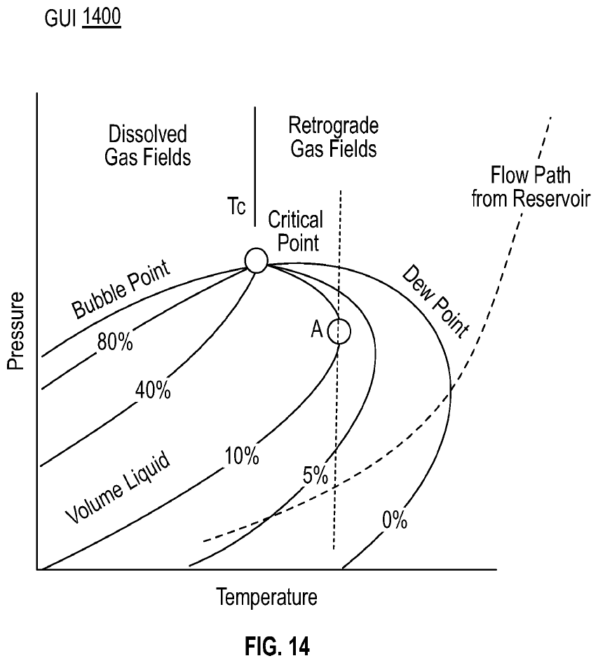

FIG. 14 shows an example of a graphical user interface 1400 that includes a phase plot (e.g., a phase diagram) with respect to pressure and temperature (e.g., noting that plots such as the plot 812 of FIG. 8, the plot 1230 and/or the plot 1250 of FIG. 12 may be rendered). As shown, various types of fields may be characterized using such a phase plot (e.g., dissolved gas, retrograde, etc.). As shown, a flow path from a reservoir may be plotted on such a phase plot that can represent a wellbore where fluid is transported from a reservoir at a particular pressure and temperature to surface, which can be at a lesser pressure and temperature. As explained, such a plot can be generated from one or more samples (e.g., sample information) and/or using one or more EoSs.

As explained, a framework can include features for phase behavior analysis. Various types of phase behavior can be illustrated via a phase plot such as the phase plot of FIG. 14. For example, a gas condensate field may produce mostly gas, with some liquid dropout, frequently occurring in a separator. As shown in FIG. 14, a retrograde gas field demands a temperature higher than the critical point temperature; noting that the vertical line on the phase plot shows the phase changes in a reservoir, while a dashed curve shows these changes as the fluid cools going up the wellbore and, for example, into a separator. In such instances, liquids can drop out as the pressure drops below dew point pressure.

With the retrograde condensate, the percent of liquid begins to increase to point “A” and then decreases with further pressure declines (“retrograde” meaning to retreat or go back). As shown, first condensation and then vaporization occurs, where such vaporization can help in further recovery of liquids.

In the example of FIG. 14, hydrocarbons above the dew point line are 100 percent gas and above the bubble point line are 100 percent liquid. Hydrocarbons above the bubble point line and close to the critical point tend to be volatile oils. The cricondentherm is the maximum temperature which two phase flow can exist (maximum temperature on the dew point line of the phase diagram); noting that a field may have both an oil leg and gas cap, which during depletion may produce some condensate from the gas.

Fields with active water drive may experience little pressure declines, so condensation occurs generally at the surface and a constant gas liquid ratio (GLR) may be expected.

As explained, when collecting samples from a hydrocarbon reservoir, some of the compositional variation can be attributed to compositional variation versus depth and some to compartmentalization. As explained, a method such as the method 700 of FIG. 7 can utilize thermodynamics and one or more techniques (e.g., comparison, machine learning, etc.) to predict compositional variation versus depth and segregate, as feasible, compositional variation associated to depth and compositional variation associated to compartmentalization.

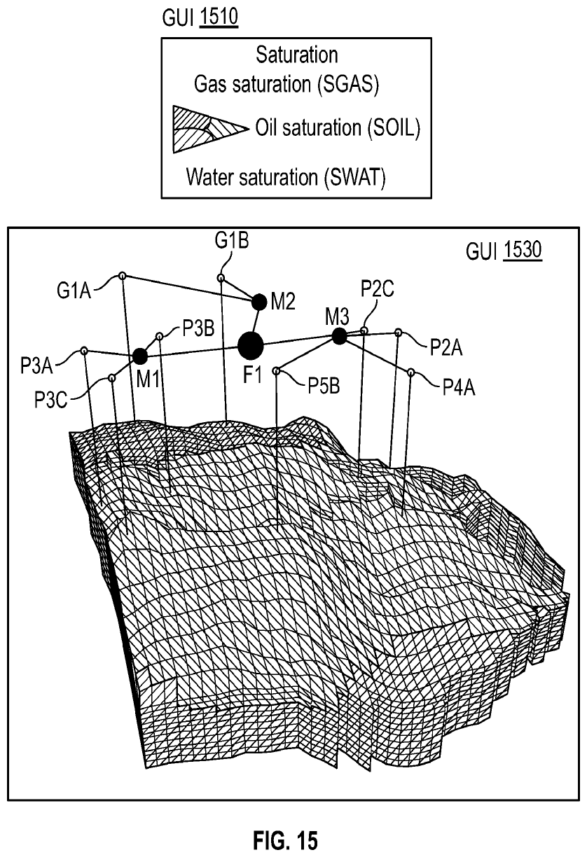

FIG. 15 shows examples of graphical user interfaces 1510 and 1530, which can show values as to saturation for gas, oil and water in a model of a system that includes a reservoir, a plurality of wells and various surface locations where fluids can mix (M1, M2 and M3) and eventually be transported to a facility (F1). As an example, output from a simulator such as described with respect to FIG. 13, may be utilized to generate one or more GUIs such as, for example, the GUIs 1510 and 1530. In the example of FIG. 15, the GUI 1530 may illustrate an original state (e.g., initial condition) or a later state, for example, a later state as based on simulation results. In the example GUI 1530, cells of a grid cell model that at least in part represents a reservoir can be assigned initial conditions, which can include compositional variation with respect to depth initial conditions.

In the example GUI 1530, the grid cell model shows grid cells as having different saturations; noting that the grid cell model can represent a reservoir that may be compartmentalized. As shown, the wells P3A-C may be in a particular region where fluid flows to the mixing location M1, the wells P2A, P2C and P4A-B may be in another region where fluid flows to the mixing location M3, and the wells G1A and G1B may be in yet another region where fluid flows to the mixing location M2. As shown, the wells G1A and G1B may be in regions of the reservoir that are gas saturated while various other wells are in oil saturated regions. As such, at the facility F1, various types of fluids can be collected where the fluids can be mixed. As explained, such a system may be handled using one or more frameworks. For example, consider using the ECLIPSE framework and/or INTERSECT framework (e.g., for a reservoir or reservoirs) and the PIPESIM framework (e.g., for a surface network or surface networks).

As an example, the method 700 of FIG. 7 can be utilized with respect to techniques, technologies, etc., as shown and explained with respect to FIGS. 13, 14 and 15. As explained, the method 700 can provide for selection of consistent EoSs and generation of appropriate initial conditions for a system that can include one or more reservoirs (e.g., optionally with compartments), two or more wells and one or more surface networks. As explained, selection of consistent EoSs can be automated and generation of appropriate initial conditions can be automated. Such an approach can provide for more effective use of simulators and improved simulation results, which may be generated in a more expeditious manner.

As an example, one or more simulations may be utilized to estimate reserves and/or fluid flow as to reserves (e.g., optionally responsive to one or more field operations such as, for example, one or more EOR operations, hydraulic fracturing, etc.).

As an example, a system can be a living integrated asset model (LAM) system that can may be operatively coupled to one or more computational frameworks. A LAM system can be for infrastructure utilized in one or more field operations that can aim to produce hydrocarbon fluids from one or more fluid reservoirs in the Earth. As an example, a LAM system may be a living asset ensemble system that includes an ensemble of models or ensembles of models.

A LAM framework and associated workflow can provide solutions to maximize the hydrocarbon production of a digitally enabled field, for example, by maintaining an underlying system that keeps models live/up-to-date with the current conditions of a reservoir or reservoirs (e.g., via data, sampling, etc.) and production for the optimizing the asset (e.g., reserves of hydrocarbons, etc.). An underlying system can acquire simulation data from current production to validate an integrated asset model, which couples single or multiple reservoirs, wells, networks, facilities and economic models (e.g., optionally an ensemble of ensembles). As an example, a LAM system can utilize and/or interact with various frameworks.

As mentioned, one or more machine learning techniques may be utilized to classify, predict, etc., with respect to samples. As explained, various types of information can be generated via operations where such information may be utilized for training one or more types of machine learning models to generate one or more trained machine learning models, which may be deployed within one or more frameworks, environments, etc.

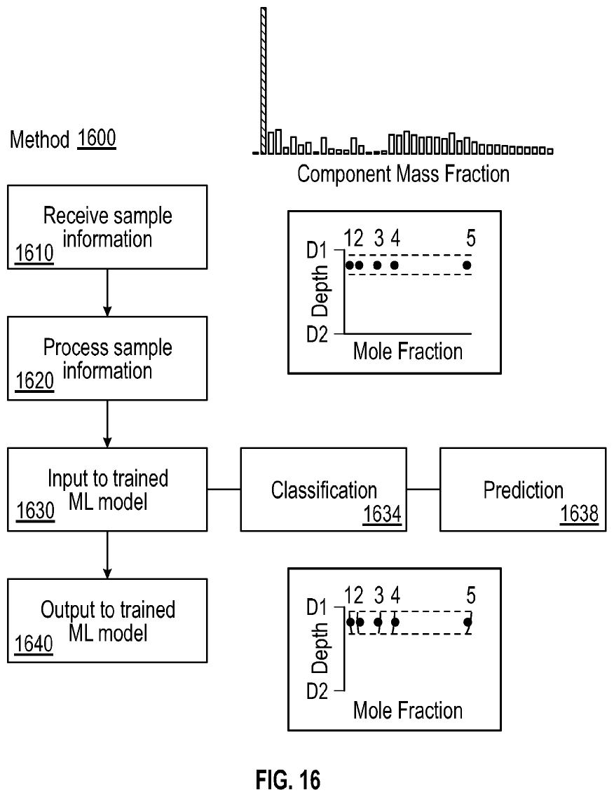

FIG. 16 shows an example of a method 1600 that can be utilized for outputting composition variation with respect to depth. As shown, the method 1600 can include a reception block 1610 for receiving sample information, a process block 1620 for processing at least a portion of the sample information, an input block 1630 for inputting processed information to a trained ML model, and an output block 1640 for outputting a result of the trained ML model.

As shown in the example of FIG. 16, the sample information of the reception block 1610 can include a component mass fraction (e.g., or mole fraction) distribution of the sample. For example, equipment can be utilized to determine a composition of a fluid sample, which may be taken downhole or at surface where the fluid sample can have an associated depth (e.g., or depth range).

As shown, the process block 1620 can process the sample information to a suitable form for input to the trained ML model of the input block 1630. In the example of FIG. 16, the process block 1620 processes the component mass fraction into a series of points in two dimensions, illustrated as depth versus mole fraction for a number of components (e.g., one to 50 components, etc.). As shown, the five components in the example are associated with a depth or depth window, which may be represented as a single dimension along a single depth or in two dimensions with a depth range (e.g., according to a depth window).

As to the input block 1630, in the example of FIG. 16, the trained ML model may utilize one or more of classification 1634 and prediction 1638 to generate output. For example, consider a classification problem where a ML model is trained to classify input into one of a variety of classes. In such an example, a number of compositional variation with respect to depth classes can exist where the trained ML model associates the input with respect to one of the number of compositional variation with respect to depth classes, which may be, for example, within a limited depth range. As to a prediction problem, it may be cast as predicting a compositional variation with respect to depth for at least a portion of a reservoir interval given a sample that provides limited amount of information about the compositional variation with respect to depth. Such an approach is not a time prediction, as a prediction of what happens at a future time given information for a past time; rather, it is a prediction based on a limited amount of information. In such an example, the trained ML model may utilize additional information such as, for example, information pertaining to one or more boundaries (e.g., rock, fluid, etc.) and/or actual depth. Such a prediction problem may involve, given a known component distribution at a depth, within a reservoir interval of 300 meters, and with GOC at 100 meters below a rock layer, what is the compositional variation with respect to depth over the reservoir interval and/or over a depth window that includes the sample depth? For example, if given a number of mole fraction values for particular components at a particular depth, what are the numerical mole fraction values at a neighboring depth to the particular depth, which may be a relationship represented in one or more hidden layers of a neural network (e.g., that mimic a physical real world relationship). In various examples, a problem may be a mixed classification and prediction problem.

As to training a ML model, consider using a database where compositional variation with respect to depth is known along with information such as one or more boundaries (e.g., rock and/or fluid) and/or pressure, temperature, etc. Such data can be labeled data where a training set can be defined along with a test set. Training can involve inputting information such as the processed information of the process block 1620 and training weights of the ML model until the input matches the labeled output. The trained ML model may then be tested to see if it adequately predicts proper output given input of the test set. Such a process can include adjusting one or more hyper-parameters, etc., with further training until testing is reliable.

As to compartmentalization, it may not be known a priori whether samples from two different wells (e.g., within a relatively small depth range, etc.) are in two different compartments. In a method such as the method 1600 of FIG. 16, output of the trained ML model per the output block 1640 can be compared to make determinations as to compartmentalization, which, as explained, can reduce uncertainty. For example, if two samples from two different wells at a similar depth differ as to compositional variation classification and/or prediction, such a difference (or differences) can indicate that they are in two different compartments. Such information may be utilized in generation of initial conditions and/or selection of EoS(s), which may be performed automatically (e.g., optionally using one or more feedback loops in a method, etc.).

As an example, a method can include performing a compartmentalization analysis and, for example, grouping samples according to compartments and performing further processing based on such grouping. For example, in the method 1160 of FIG. 11, the comparison block 1176 may provide determinations as to compartmentalization that can be considered by the execution block 1180, which may facilitate further processing in a manner that can increase accuracy for purposes of model building and/or model initialization. As mentioned, a determination as to compartmentalization may be utilized as feedback. For example, consider feedback to the method 1110 where selection, ranking and/or output of one or more EoSs may be performed on the basis of such a determination (e.g., to assure each compartment utilizes an appropriate EoS, etc.). Such an approach can aim to increase consistency and accuracy as to physical conditions that exist in one or more real world reservoirs.

As explained, a training process can utilize labeled datasets, which can involve supervised learning to help assure that a ML model can learn a relationship between labels and data. Supervised learning problems arise in tasks such as face-detection and voice detection, where, generally, the amount of input data is sufficient. As an example, in classification, a deep learning approach may be implemented, which can, for example, associate points in plot and with a compositional variation versus depth, each of which may be optionally presented in image form (e.g., as a 2D image of pixels, etc.).

As explained, a method may implement clustering or grouping, which can be a problem of recognition of similarities. Where such an approach utilizes a ML model, training may be supervised and/or unsupervised. For example, the cluster block 1168 of the method 1160 may utilize a ML model for clustering samples, which, as explained, may help to reduce uncertainty and/or complexity (e.g., reduce computational demands as to subsequent processing, etc.).

As an example, a combined regression (prediction) and classification ML model may be constructed. For example, consider an architecture with an input layer, hidden layers and multiple output layers. In such an example, regression and classification output layers can be connected to a common last hidden layer of the model. Given two output layers, a model may be trained using two loss functions, for example, consider a mean squared error (MSE) loss for the regression output layer and a sparse categorical cross-entropy for the classification output layer.

An example of a combined ML model for regression (prediction) and classification can be for determining the age of an abalone from physical details where predicting the number of rings of the abalone is a proxy for the age of the abalone (e.g., age can be predicted as both a numerical value (in years) or a class label (ordinal year as a class)). In compositional gradient versus depth, numerical values may be predicted with respect to depth (e.g., for one or more components of a sample for neighboring depths about a sample depth) or a class approach may be utilized (e.g., where different scenarios correspond to different classes, which may be represented as images, etc.). In various examples, a trained ML model may output probability information. For example, consider a probability that input belongs to a particular class. Such information may be utilized to reduce uncertainty in a method such as, for example, the method 700 of FIG. 7.

As to types of machine learning (ML) models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naive Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine learning model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

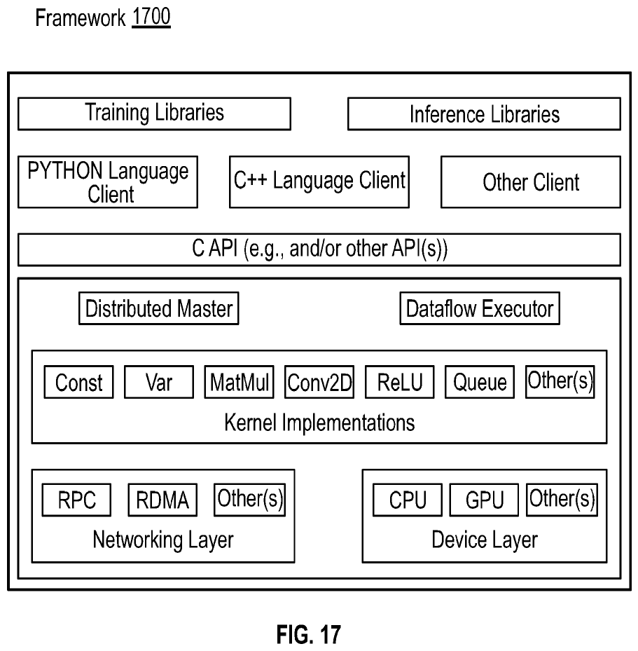

FIG. 17 shows an architecture 1700 of a framework such as the TENSORFLOW framework. As shown, the architecture 1700 includes various features. As an example, in the terminology of the architecture 1700, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

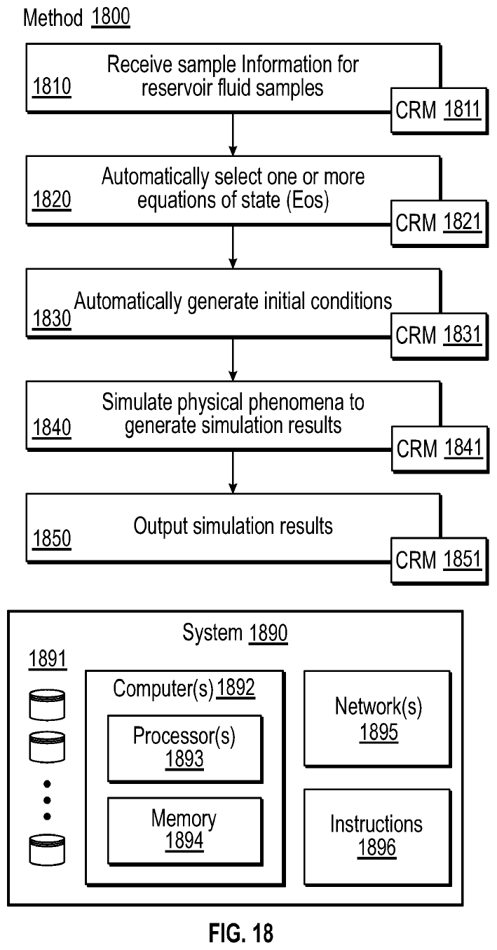

FIG. 18 shows an example of a method 1800 and an example of a system 1890. As shown, the method 1800 includes a reception block 1810 for receiving sample information for reservoir fluid samples; a selection block 1820 for automatically selecting one or more equations of state from a plurality of different equations of state; a generation block 1830 for automatically generating initial conditions based at least in part on the sample information; a simulation block 1840 for simulating physical phenomena using at least a reservoir model to generate simulation results, where the simulating utilizes the selected one or more equations of state and the initial conditions; and an output block 1850 for outputting at least a portion of the simulation results. In such an example, the simulation results can characterize at least a reservoir as represented by the reservoir model. For example, consider characterizing an ability of a reservoir to produce hydrocarbons given one or more wells, which may include a planned well to be drilled, a partially drilled well, an existing well, etc.

The method 1800 is shown as including various computer-readable storage medium (CRM) blocks 1811, 1821, 1831, 1841 and 1851 that can include processor-executable instructions that can instruct a computing system, which can be a control system, to perform one or more of the actions described with respect to the method 1800.

In the example of FIG. 18, the system 1890 includes one or more information storage devices 1891, one or more computers 1892, one or more networks 1895 and instructions 1896. As to the one or more computers 1892, each computer may include one or more processors (e.g., or processing cores) 1893 and memory 1894 for storing the instructions 1896, for example, executable by at least one of the one or more processors 1893 (see, e.g., the blocks 1811, 1821, 1831, 1841 and 1851). As an example, a computer may include one or more network interfaces (e.g., wired or wireless), one or more graphics cards, a display interface (e.g., wired or wireless), etc.

As an example, a method can include receiving sample information for reservoir fluid samples; automatically selecting one or more equations of state from a plurality of different equations of state; automatically generating initial conditions based at least in part on the sample information; simulating physical phenomena using at least a reservoir model to generate simulation results, where the simulating utilizes the selected one or more equations of state and the initial conditions; and outputting at least a portion of the simulation results. In such an example, the initial conditions can include compositional variation with respect to depth of reservoir fluid for the reservoir model.

As an example, a method can include automatically generating initial conditions in a manner that involves detecting reservoir compartmentalization. For example, consider initial conditions that include a first set of initial conditions for a first reservoir compartment and a second set of initial conditions for a second reservoir compartment, where the initial conditions of the first set and the second set differ. As an example, a method can include detecting reservoir compartmentalization in a manner that includes comparing compositional variation with respect to depth in different areal regions. In such an example, a comparison may compare one or more fluid boundaries (e.g., fluid-fluid boundaries) in one areal region to another areal region where a difference in vertical depth can indicate compartmentalization.

As an example, a method can include automatically generating initial conditions in a manner that involves determining a location of a fluid-fluid boundary. For example, consider a fluid-fluid boundary that corresponds to gas-oil contact or to oil-water contact.

As an example, a method can include automatically generating initial conditions in a manner that includes implementing a trained machine learning model that outputs compositional variation with respect to depth based at least in part on at least a portion of sample information for one or more reservoir fluid samples.

As an example, a method can include automatically selecting one or more equations of state in a manner that includes selecting an equation of state for a reservoir location and selecting another, different equation of state for a surface location. In such an example, the surface location can correspond to a well mixing location where fluid from two or more wells mix. In such an example, a simulation can include simulating physical phenomena at the well mixing location. In such an example, the well mixing location can be in fluid communication with a processing facility where, for example, simulating includes simulating physical phenomena at the processing facility (e.g., at an inlet, within the facility, etc.).

As an example, a method can include automatically selecting one or more equations of state in a manner that includes testing at least a portion of a plurality of different equations of state with respect to at least a portion of sample information.

As an example, a method can include automatically selecting one or more equations of state in a manner that includes ranking at least a portion of a plurality of different equations of state.

As an example, a method can include automatically generating initial conditions in a manner that includes subdividing a reservoir interval into depth windows. In such an example, the method can include estimating a compositional variation with respect to depth for each of the depth windows and, for example, computing a composition variation with respect to depth for a depth span that encompasses more than two of the depth windows.

As an example, a method can include automatically generating initial conditions in a manner that includes clustering reservoir fluid samples based at least in part on sample information to effectively reduce sample number of the reservoir fluid samples. In such an example, a method can include clustering that aims to generate clusters on one or both sides of a fluid boundary. As explained, where a fluid boundary exists (e.g., contact), a clustering technique may aim to generate at least one cluster on each side of the fluid boundary to assist with estimation of a location of the fluid boundary.

As an example, a system can include a processor; a memory accessibly by the processor; and instructions stored in the memory and executable by the processor to instruct the system to: receive sample information for reservoir fluid samples; automatically select one or more equations of state from a plurality of different equations of state; automatically generate initial conditions based at least in part on the sample information; perform simulation of physical phenomena using at least a reservoir model to generate simulation results, where the simulation utilizes the selected one or more equations of state and the initial conditions; and outputting at least a portion of the simulation results.

As an example, one or more computer-readable storage media can include processor-executable instructions where the processor-executable instructions include instructions to instruct a computing system to: receive sample information for reservoir fluid samples; automatically select one or more equations of state from a plurality of different equations of state; automatically generate initial conditions based at least in part on the sample information; perform simulation of physical phenomena using at least a reservoir model to generate simulation results, where the simulation utilizes the selected one or more equations of state and the initial conditions; and outputting at least a portion of the simulation results.

As an example, a method for building EoSs may include, automatically building a plurality of EoSs with a different number of components and pseudo-components in each EoS. The method may also include, assessing a quality of the different EoSs automatically built. The method may also include, ranking the different EoSs. As an example, a method may include, automatically selecting a set of viable equations of state (EoS) for a reservoir. Such a method may include, optimizing a solution utilizing an optimization workflow. Such a method may also include, automatically determining a full list of potential compositional variation versus depth from samples. Such a method may also include, comparing results. The second method may also include, identifying ranges of variability. As an example, a method may include clustering to reduce uncertainty by identifying apparent compartments and assessing composition variability with each compartment.

As an example, a computer program product can include one or more computer-readable storage media that can include processor-executable instructions to instruct a computing system to perform one or more methods and/or one or more portions of a method.

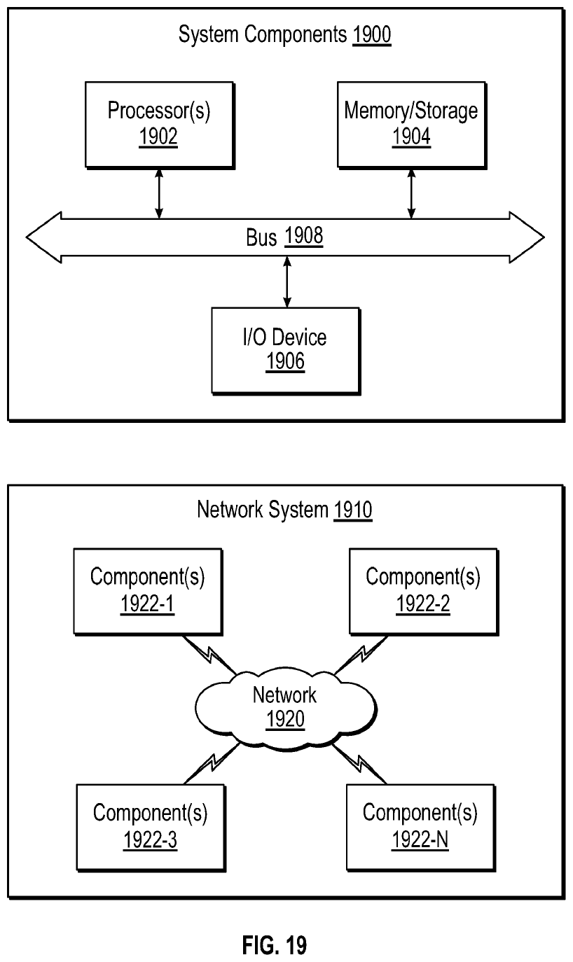

FIG. 19 shows components of an example of a computing system 1900 and an example of a networked system 1910 with a network 1920. The system 1900 includes one or more processors 1902, memory and/or storage components 1904, one or more input and/or output devices 1906 and a bus 1908. In an example embodiment, instructions may be stored in one or more computer-readable media (e.g., memory/storage components 1904). Such instructions may be read by one or more processors (e.g., the processor(s) 1902) via a communication bus (e.g., the bus 1908), which may be wired or wireless. The one or more processors may execute such instructions to implement (wholly or in part) one or more attributes (e.g., as part of a method). A user may view output from and interact with a process via an I/O device (e.g., the device 1906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1910. The network system 1910 includes components 1922-1, 1922-2, 1922-3, . . . 1922-N. For example, the components 1922-1 may include the processor(s) 1902 while the component(s) 1922-3 may include memory accessible by the processor(s) 1902. Further, the component(s) 1922-2 may include an I/O device for display and optionally interaction with a method. The network 1920 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

In varying circumstances, those with skill in the art may also practice the disclosed invention according to the following embodiments.

In an embodiment, a method (1800) is provided, comprising: receiving sample information for reservoir fluid samples (1810); automatically selecting one or more equations of state from a plurality of different equations of state (1820); automatically generating initial conditions based at least in part on the sample information (1830); simulating physical phenomena using at least a reservoir model to generate simulation results, wherein the simulating utilizes the selected one or more equations of state and the initial conditions (1840); and outputting at least a portion of the simulation results (1850).

In a further embodiment, the foregoing method (1800) includes wherein the initial conditions comprise compositional variation with respect to depth of reservoir fluid for the reservoir model.

In a further embodiment, the foregoing methods include wherein automatically generating initial conditions comprises detecting reservoir compartmentalization.

In a further embodiment, the foregoing methods include wherein the initial conditions comprise a first set of initial conditions for a first reservoir compartment and a second set of initial conditions for a second reservoir compartment, wherein the initial conditions of the first set and the second set differ.

In a further embodiment, the foregoing methods include wherein detecting reservoir compartmentalization comprises comparing compositional variation with respect to depth in different areal regions.

In a further embodiment, the foregoing methods include wherein automatically generating initial conditions comprises determining a location of a fluid-fluid boundary, wherein the fluid-fluid boundary corresponds to gas-oil contact or to oil-water contact.

In a further embodiment, the foregoing methods include wherein automatically selecting one or more equations of state comprises selecting an equation of state for a reservoir location and selecting another, different equation of state for a surface location, optionally wherein the surface location corresponds to a well mixing location where fluid from two or more wells mix and optionally wherein the simulating comprises simulating physical phenomena at the well mixing location.

In a further embodiment, the foregoing methods include wherein automatically selecting one or more equations of state comprises testing at least a portion of the plurality of different equations of state with respect to at least a portion of the sample information.

In a further embodiment, the foregoing methods include wherein automatically selecting one or more equations of state comprises ranking at least a portion of the plurality of different equations of state.

In a further embodiment, the foregoing methods include wherein automatically generating initial conditions comprises subdividing a reservoir interval into depth windows.

In a further embodiment, the foregoing methods include estimating a compositional variation with respect to depth for each of the depth windows.

In a further embodiment, the foregoing methods include computing a composition variation with respect to depth for a depth span that encompasses more than two of the depth windows.

In a further embodiment, the foregoing methods include wherein automatically generating initial conditions comprises clustering the reservoir fluid samples based at least in part on the sample information to effectively reduce sample number of the reservoir fluid samples.

In an embodiment, a system (1890) is provided, comprising: a processor (1893); a memory (1894) accessibly by the processor; and instructions (1896) stored in the memory and executable by the processor to instruct the system to perform the method 1800 or any of the methods described in the foregoing further embodiments.

In an embodiment, a computer program product is provided that comprises computer-executable instructions to instruct a computing system to perform the method 1800 or any of the methods described in the foregoing further embodiments.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving sample information for reservoir fluid samples;
automatically selecting one or more equations of state from a plurality of different equations of state;
automatically generating initial conditions based at least in part on the sample information;
simulating physical phenomena using at least a reservoir model to generate simulation results, wherein the simulating utilizes the selected one or more equations of state and the initial conditions; and
outputting at least a portion of the simulation results.

2. The method of claim 1, wherein the initial conditions comprise compositional variation with respect to depth of reservoir fluid for the reservoir model.

3. The method of claim 1, wherein automatically generating initial conditions comprises detecting reservoir compartmentalization.

4. The method of claim 3, wherein the initial conditions comprise a first set of initial conditions for a first reservoir compartment and a second set of initial conditions for a second reservoir compartment, wherein the initial conditions of the first set and the second set differ.

5. The method of claim 3, wherein detecting reservoir compartmentalization comprises comparing compositional variation with respect to depth in different areal regions.

6. The method of claim 1, wherein automatically generating initial conditions comprises determining a location of a fluid-fluid boundary.

7. The method of claim 6, wherein the fluid-fluid boundary corresponds to gas-oil contact.

8. The method of claim 6, wherein the fluid-fluid boundary corresponds to oil-water contact.

9. The method of claim 1, wherein automatically selecting one or more equations of state comprises selecting an equation of state for a reservoir location and selecting another, different equation of state for a surface location.

10. The method of claim 9, wherein the surface location corresponds to a well mixing location where fluid from two or more wells mix.

11. The method of claim 10, wherein the simulating comprises simulating physical phenomena at the well mixing location.

12. The method of claim 11, wherein the well mixing location is in fluid communication with a processing facility and wherein the simulating comprises simulating physical phenomena at the processing facility.

13. The method of claim 1, wherein automatically selecting one or more equations of state comprises testing at least a portion of the plurality of different equations of state with respect to at least a portion of the sample information.

14. The method of claim 1, wherein automatically selecting one or more equations of state comprises ranking at least a portion of the plurality of different equations of state.

15. The method of claim 1, wherein automatically generating initial conditions comprises subdividing a reservoir interval into depth windows.

16. The method of claim 15, comprising estimating a compositional variation with respect to depth for each of the depth windows.

17. The method of claim 16, comprising computing a composition variation with respect to depth for a depth span that encompasses more than two of the depth windows.

18. The method of claim 1, wherein automatically generating initial conditions comprises clustering the reservoir fluid samples based at least in part on the sample information to effectively reduce sample number of the reservoir fluid samples.

19. A system comprising:
a processor;
a memory accessibly by the processor; and
instructions stored in the memory and executable by the processor to instruct the system to:
receive sample information for reservoir fluid samples;
automatically select one or more equations of state from a plurality of different equations of state;
automatically generate initial conditions based at least in part on the sample information;
perform simulation of physical phenomena using at least a reservoir model to generate simulation results, wherein the simulation utilizes the selected one or more equations of state and the initial conditions; and
outputting at least a portion of the simulation results.

20. One or more computer-readable storage media comprising processor-executable instructions wherein the processor-executable instructions comprise instructions to instruct a computing system to:
receive sample information for reservoir fluid samples;
automatically select one or more equations of state from a plurality of different equations of state;
automatically generate initial conditions based at least in part on the sample information;
perform simulation of physical phenomena using at least a reservoir model to generate simulation results, wherein the simulation utilizes the selected one or more equations of state and the initial conditions; and
outputting at least a portion of the simulation results.
